(19) United States
(12) Patent Application Publication
(10) Pub. No.: US 2026/0016807 A1
(43) Pub. Date: Jan. 15, 2026

(54) PARAMETER ADJUSTMENT DEVICE AND PARAMETER ADJUSTMENT METHOD

(71) Applicant: Mitsubishi Electric Corporation, Tokyo (JP)

(72) Inventors: Seiji UOZUMI, Tokyo (JP); Jun MARUTA, Tokyo (JP); Yuta NAKANISHI, Tokyo (JP); Shinya NISHINO, Tokyo (JP)

(73) Assignee: Mitsubishi Electric Corporation, Tokyo (JP)

(21) Appl. No.: 19/138,122

(22) PCT Filed: Jun. 28, 2023
(86) PCT No.: PCT/JP2023/024058

§ 371 Date: Jun. 12, 2025

(51) Int. Cl. G05B 19/4093; G05B 19/4103

(52) U.S. Cl. CPC G05B 19/40932; G05B 19/4103

(57) ABSTRACT

In a parameter adjustment device, the feature calculation unit calculates a feature of machining by simulating an operation of a machine tool from the tool travel command. The evaluation index calculation unit calculates evaluation index values for evaluating a machining result from the feature of machining. The first optimal solution search unit infers the evaluation index values corresponding to a first search command value generation parameter set by using a first learning result, and, by using a result of the inference, searches for command value generation parameter set candidates that simultaneously optimize the respective evaluation index values. The display control unit displays the feature of machining calculated when the command value generation parameter set candidates are set on a command value generation device that generates the tool travel command, and the respective evaluation index values.

### FIELD

The present disclosure relates to a parameter adjustment device that adjusts a parameter related to command value generation in a command value generation device that generates a tool travel command for driving a drive device of a machine tool on the basis of a machining program, and a parameter adjustment method.

### BACKGROUND

In a case where a workpiece is machined into a desired shape by using a machine tool, a machining program is generally created by computer-aided manufacturing (CAM) or the like. In the machining program, information on a machining shape, a feed rate of a tool, the number of rotations of the tool, and the like are described. A command value generation device reads the machining program and performs coordinate conversion, tool length correction, tool diameter correction, machine error correction, and the like to calculate a tool path. Furthermore, the command value generation device performs a process of acceleration/deceleration and the like, and calculates an interpolation point which is a command point on the tool path per unit time. In many cases, a numerical control (NC) is used as the command value generation device.

The command value generation device is equipped with a large number of functions for performing machining by the machine tool at higher speed and with higher accuracy. It is necessary for a worker to determine a case of placing emphasis on a cycle time, that is, a machining time, a case of placing emphasis on machining accuracy which is shape accuracy of a machined surface, and a case of placing emphasis on surface quality which is surface accuracy of the machined surface, depending on the shape, application, and the like of a workpiece to be machined, and to adjust a huge number of parameters related to these functions. Therefore, it requires a huge amount of time for parameter adjustment work for the command value generation device, or the adjustment work becomes complicated, and thus adjustment in line with the worker's preference cannot be performed, which is a problem. Patent Literature 1 discloses a technique for supporting parameter adjustment in such a case by executing a test program with a plurality of parameter settings and selecting a parameter set with which a best value is obtained for an evaluation index determined from machining accuracy and machining time.

### CITATION LIST

### Patent Literature

Patent Literature 1: Japanese Patent No. 5956619

### SUMMARY OF INVENTION

### Problem to be Solved by the Invention

However, with the technique described in Patent Literature 1, in a case where the test program used for parameter adjustment includes a difference from the shape of a workpiece to be machined by a worker, the accuracy of the parameter adjustment deteriorates, and thus an adjustment result in line with the worker's preference cannot be obtained. On the other hand, when maintaining the accuracy of the parameter adjustment in order to obtain the adjustment result in line with the worker's preference, it is necessary to achieve convergence on the worker's preference by repeating a series of work operations many times in which the test program is changed or an adjustment range is corrected for each parameter, and then the parameter adjustment work is started again from the first step. In a case where the parameters are converged on the worker's preference, conventionally, it is necessary to perform the parameter adjustment work by trial and error, so that the worker is burdened with additional labor and time. Therefore, there has been a demand for a technique capable of further focusing on the worker's preference in the parameter adjustment than the prior art.

The present disclosure has been made in view of the above, and an object thereof is to provide a parameter adjustment device capable of achieving convergence of parameters related to a command value in line with a worker's preference faster than before.

### Means to Solve the Problem

In order to solve the above-described problem and achieve the object, a parameter adjustment device according to the present disclosure is a parameter adjustment device that adjusts a command value generation parameter set which is a plurality of parameters used to generate a tool travel command including a group of interpolation points per unit time on a tool path calculated on the basis of a machining program for machining a workpiece, and includes a feature calculation unit, an evaluation index calculation unit, a first optimal solution search unit, and a display control unit. The feature calculation unit calculates a feature of machining by simulating an operation of a machine tool to be controlled on a basis of the tool travel command. The evaluation index calculation unit calculates one or more evaluation index values for evaluating a machining result from the feature of machining. A first optimal solution search unit infers the evaluation index values corresponding to a first search command value generation parameter set by using a first learning result for inferring the evaluation index values from the command value generation parameter set that has been learned by using the command value generation parameter set and the evaluation index values, and, by using a result of the inference, searches for command value generation parameter set candidates which are a plurality of command value generation parameter sets that simultaneously optimize the respective evaluation index values. The display control unit displays, on a display unit, the feature of machining calculated when the command value generation parameter set candidates are set on a command value generation device that generates the tool travel command and the command value generation device operates, and the respective evaluation index values in association with each other.

### Effects of the Invention

The parameter adjustment device according to the present disclosure achieves an effect that it is possible to achieve convergence of parameters related to a command value in line with a worker's preference faster than before.

### BRIEF DESCRIPTION OF DRAWINGS

FIG. 1 is a diagram illustrating an example of a configuration of a parameter adjustment device according to a first embodiment.

FIG. 2 is a view illustrating an example of a machining target shape.

FIG. 3 is a view illustrating an example of the machining target shape.

FIG. 4 is a view illustrating an example of the machining target shape.

FIG. 5 is a diagram illustrating an example of a machining program for machining the machining target shape illustrated in FIGS. 2 to 4.

FIG. 6 is a diagram illustrating an example of a change in an acceleration/deceleration waveform when an allowable acceleration changes.

FIG. 7 is a diagram illustrating an example of a change in a travel path when an allowable path error changes.

FIG. 8 is a diagram illustrating an example of a change in an acceleration/deceleration waveform when the allowable path error changes.

FIG. 9 is a diagram illustrating an example of a change in a travel path of a tool when a filter time constant changes.

FIG. 10 is a diagram illustrating an example of a change in an acceleration/deceleration waveform when the filter time constant changes.

FIG. 11 is a diagram illustrating examples of mapping diagrams of the amounts of machining error of a machined curved surface in the machining target shape in a case of performing machining operations generated on the basis of first to fourth command value generation parameter sets and relationships thereof with machining times.

FIG. 12 is a diagram illustrating an example of a neural network used in a learning process of the first embodiment.

FIG. 13 is a diagram illustrating examples of command value generation parameter sets for a machined curved surface searched for by a first optimal solution search unit in the first embodiment.

FIG. 14 is a diagram illustrating an example of setting of preference information by a worker for one command value generation parameter set candidate selected from among categories of a machining time priority mode, a machining accuracy priority mode, a surface quality priority mode, and a balance mode for the machined curved surface illustrated in FIG. 13.

FIG. 15 is a flowchart illustrating an example of a procedure of a parameter adjustment method according to the first embodiment.

FIG. 16 is a diagram illustrating an example of how a member in a blade shape is machined.

FIG. 17 is a diagram illustrating an example of a configuration of a parameter adjustment device according to a second embodiment.

FIG. 18 is a flowchart illustrating an example of a procedure of a parameter adjustment method according to the second embodiment.

FIG. 19 is a diagram illustrating an example of a configuration of a computer system that realizes the parameter adjustment devices according to the first and second embodiments.

### DESCRIPTION OF EMBODIMENTS

Hereinafter, a parameter adjustment device and a parameter adjustment method according to each embodiment of the present disclosure will be described in detail with reference to the drawings.

### First Embodiment

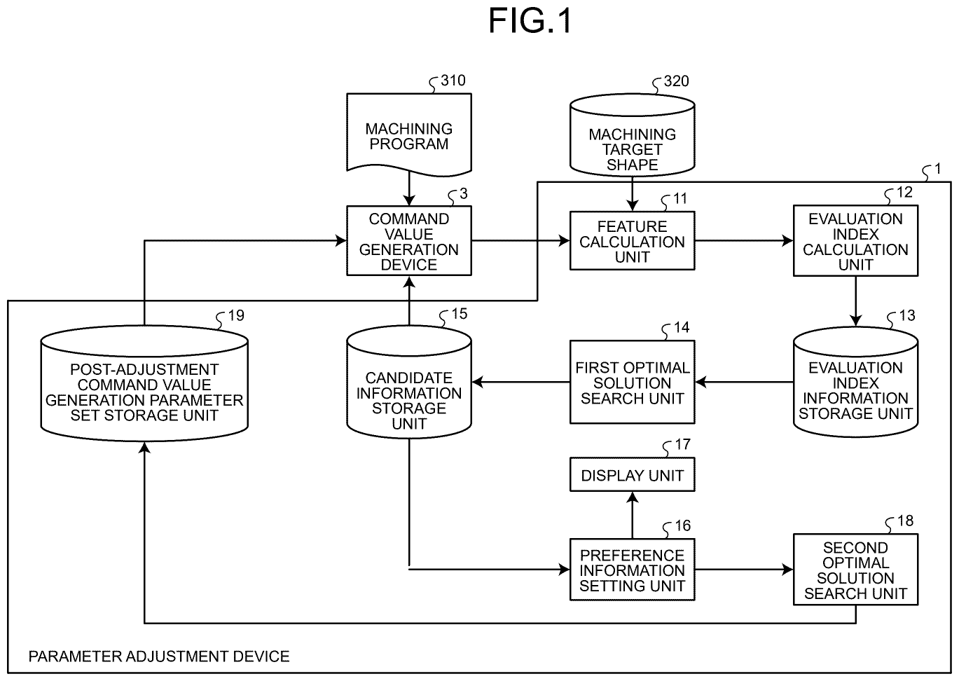

FIG. 1 is a diagram illustrating an example of a configuration of a parameter adjustment device according to a first embodiment. A parameter adjustment device 1 is a device that adjusts a command value generation parameter set which is a plurality of parameters used to generate a tool travel command including a group of interpolation points per unit time on a tool path calculated on the basis of a machining program for machining a workpiece. The tool travel command is a command for driving a drive device such as a servo motor of a machine tool.

A command value generation device 3 outputs a tool travel command per unit time to the parameter adjustment device 1 in accordance with a machining program 310 that has been externally input. The machining program 310 is a computer program in which a tool path travel command corresponding to a machining target shape 320 and a travel velocity command at that time are described. Regarding the tool path travel command, coordinate values and a travel mode at that time are designated by a G-code such as G0 or G1, and a tool path travel velocity command is designated by an F-code in which a velocity value is described.

The machining target shape 320 is target shape data of a workpiece including a machined curved surface which is a curved surface to be machined. The machining target shape 320 is externally input to the parameter adjustment device 1. In one example, the machining target shape 320 is input to the parameter adjustment device 1 by a method such as input by data conversion from computer-aided design (CAD) data or graphic input by a worker operating a keyboard or the like.

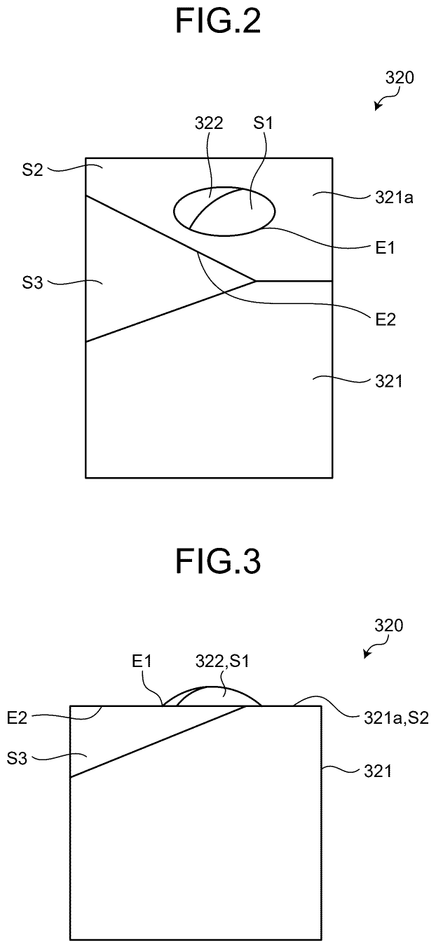

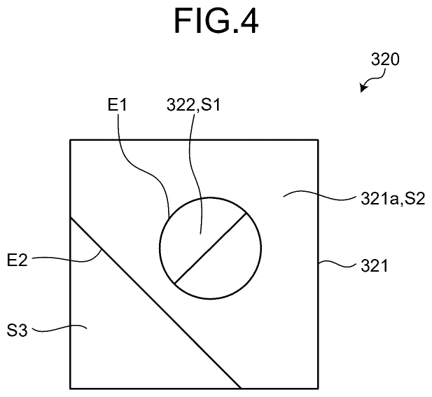

FIGS. 2 to 4 are each a view illustrating an example of the machining target shape. FIG. 2 is a perspective view of the machining target shape 320, FIG. 3 is a front view of the machining target shape 320, and FIG. 4 is a top view of the machining target shape 320. The machining target shape 320 includes a protrusion 322 in a hemispherical shape on an upper surface 321a of a block 321 having a rectangular parallelepiped shape. Also, the machining target shape 320 has a shape in which one corner of the upper surface 321a is cut out by a plane. When attention is paid to the upper surface 321a, the machining target shape 320 includes a machined curved surface S1 forming the protrusion 322 in a hemispherical shape, a machined curved surface S2 in a planar shape forming a region other than the machined curved surface S1 of the upper surface 321a, and a machined curved surface S3 on a plane at a position where the corner is cut off. In addition, a machined edge E1 in an annular shape is present at a boundary between the machined curved surface S1 and the machined curved surface S2, and a machined edge E2 in a linear shape is present at a boundary between the machined curved surface S2 and the machined curved surface S3.

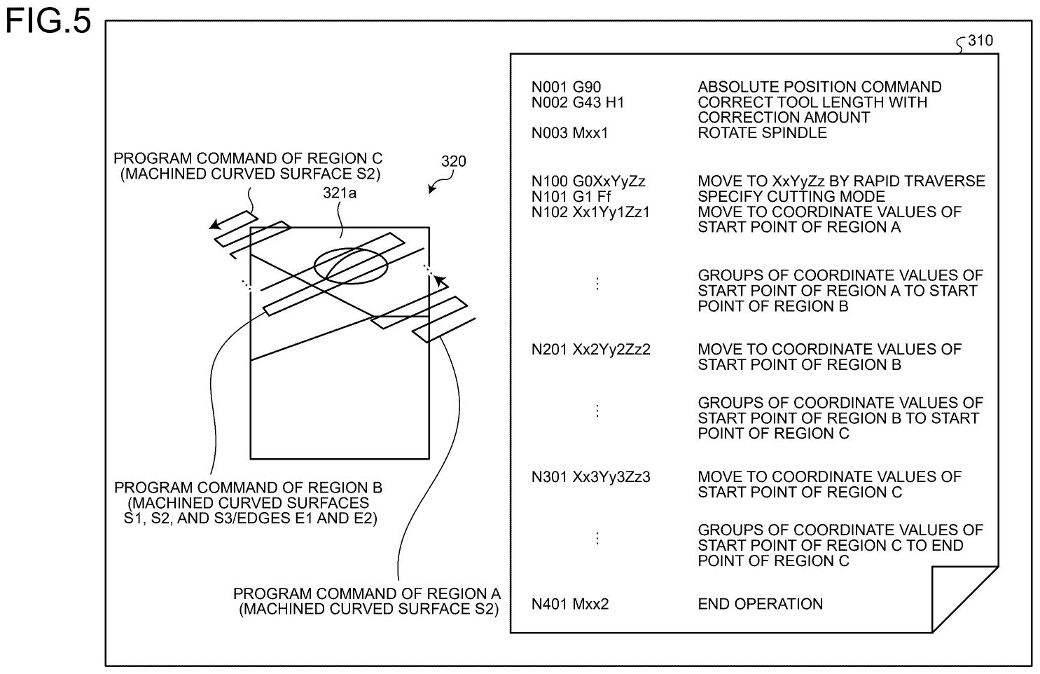

FIG. 5 is a diagram illustrating an example of a machining program for machining the machining target shape illustrated in FIGS. 2 to 4. A process is described in the machining program 310, which is a process of operating the machine tool so that the upper surface 321a of the block 321 having a rectangular parallelepiped shape is formed into the machining target shape 320 illustrated in FIGS. 2 to 4. In the example illustrated in FIG. 5, a machining path of scanning line machining is used as an example, but contour machining may also be used. In addition, the machining direction is not limited.

The command value generation device 3 performs an analysis process, an acceleration/deceleration process, a leveling process, a smoothing process, an interpolation process, and the like when outputting a tool travel command per unit time in accordance with the machining program 310 that has been externally input. The analysis process is a process of outputting a travel path and a feed rate on the travel path on the basis of the machining program 310. The acceleration/deceleration process is a process of calculating an acceleration/deceleration waveform between a stopped state and a feed rate state on the basis of a preset allowable acceleration. The leveling process is a process of outputting a travel command in which a travel path is leveled on the basis of a preset allowable path error and the acceleration/deceleration waveform. The smoothing process is a process of smoothing a velocity waveform after the leveling process. The smoothing process is also called a moving average filtering process. The interpolation process is a process of calculating an interpolation point which is a tool position per unit time when the tool moves at the velocity after the smoothing process. Here, each of the tool travel commands per unit time is referred to as an interpolation point.

Respective processes in the command value generation device 3 operate in accordance with parameters. The parameters will be described below.

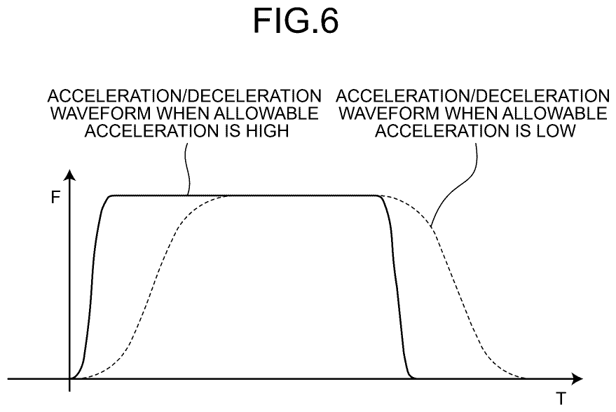

In the acceleration/deceleration process, the acceleration/deceleration waveform changes depending on an allowable acceleration to be set. That is, the allowable acceleration is a parameter. FIG. 6 is a diagram illustrating an example of a change in an acceleration/deceleration waveform when an allowable acceleration changes. In this figure, the horizontal axis represents time and the vertical axis represents speed. A graph indicated by a solid line is an acceleration/deceleration waveform when the allowable acceleration is high, and a graph indicated by a broken line is an acceleration/deceleration waveform when the allowable acceleration is low. According to FIG. 6, it can be seen that by lowering the allowable acceleration, a smooth acceleration/deceleration waveform with a low acceleration is obtained as compared with a case where the allowable acceleration is high, but the machining time increases.

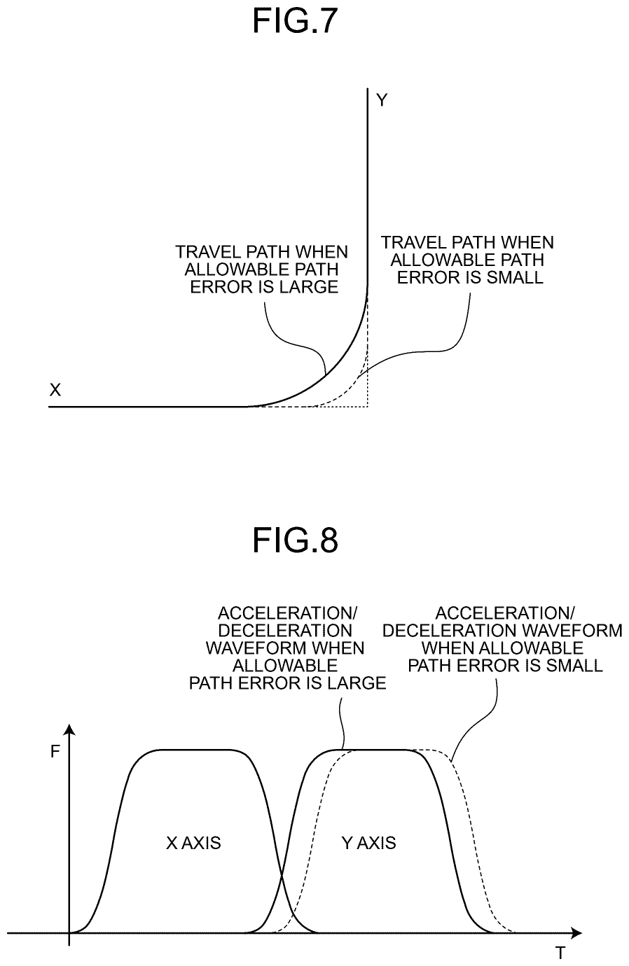

In the leveling process, the travel command and the velocity waveform change depending on the allowable path error to be set. That is, the allowable path error is a parameter. FIG. 7 is a diagram illustrating an example of a change in the travel path when the allowable path error changes, and FIG. 8 is a diagram illustrating an example of a change in the acceleration/deceleration waveform when the allowable path error changes. In FIG. 8, the horizontal axis represents time and the vertical axis represents speed. In FIG. 7, the travel path of the tool in the machining program 310 proceeds along the X axis and then proceeds along the Y axis as indicated by a dotted line. A travel path indicated by a solid line is a travel path when the allowable path error is large, and a travel path indicated by a broken line is a travel path when the allowable path error is small. FIG. 8 illustrates an acceleration/deceleration waveform in an X-axis direction and acceleration/deceleration waveforms in a Y-axis direction when machining is performed along the travel path in FIG. 7. In addition, regarding the acceleration/deceleration waveforms in the Y-axis direction, a solid line indicates one in a case where the allowable path error is large, and a broken line indicates one in a case where the allowable path error is small. As can be seen from FIGS. 7 and 8, by increasing the allowable path error, the machining time can be shortened as compared with the case where the allowable path error is small, but a path error of the tool increases.

In the smoothing process, the tool travel command and the velocity waveform change so as to be smooth depending on a time constant of a moving average filter to be set. Hereinafter, the time constant of the moving average filter is referred to as a filter time constant. In this process, the filter time constant is a parameter. Since an interpolation point x on a post-moving-average-filter path, that is, a path of the tool travel command is expressed by an average value of points X on a pre-moving-average-filter path, that is, a path of the machining program 310, an interpolation point x can be expressed by the following formula (1).

$$\begin{matrix}Formula 1 & \\ x ( n ) = \frac{X ( n - m + 1 ) + X ( n - m + 2 ) + … + X ( n )}{m} & ( 1 )\end{matrix}$$

Here, n represents interpolation point numbers from a start point to an end point. Furthermore, m is a filter time constant of the moving average filter, and is set by a parameter.

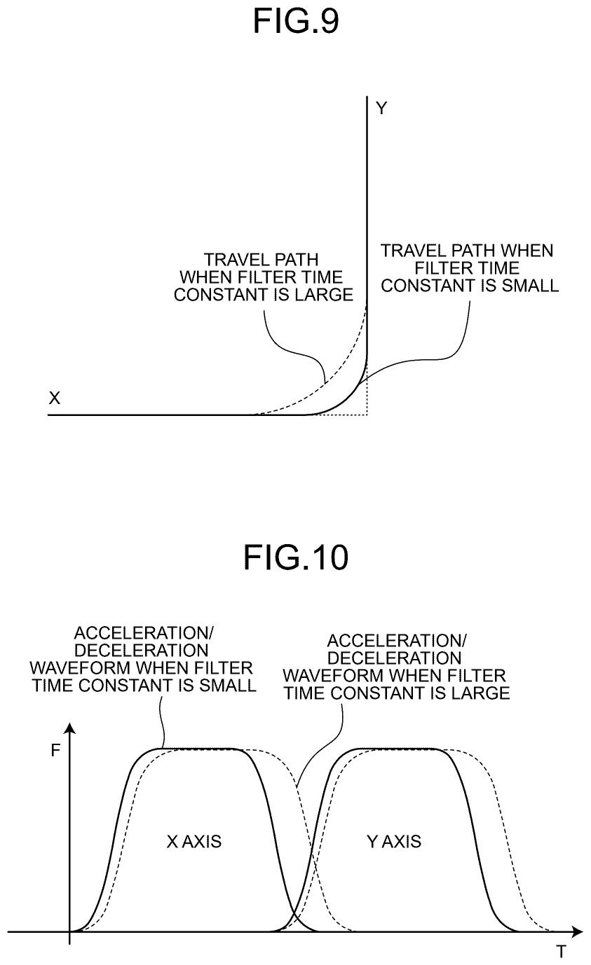

FIG. 9 is a diagram illustrating an example of a change in the travel path of the tool when the filter time constant changes, and FIG. 10 is a diagram illustrating an example of a change in the acceleration/deceleration waveform when the filter time constant changes. In FIG. 10, the horizontal axis represents time and the vertical axis represents speed. In FIG. 9, the travel path of the tool in the machining program 310 proceeds along the X axis and then proceeds along the Y axis as indicated by a dotted line. A travel path indicated by a solid line is a travel path when the filter time constant is small, and a travel path indicated by a broken line is a travel path when the filter time constant is large. FIG. 10 illustrates acceleration/deceleration waveforms in the X-axis direction and acceleration/deceleration waveforms in the Y-axis direction when machining is performed along the travel path in FIG. 9. Each broken line indicates one in a case where the filter time constant is large, and each solid line indicates one in a case where the filter time constant is small. As can be seen from FIGS. 9 and 10, by increasing the filter time constant of the moving average filter, a smooth acceleration/deceleration waveform can be obtained as compared with the case where the filter time constant is small, but the machining time and the path error of the tool increase.

As described below, in the first embodiment, the parameter adjustment device 1 treats a total of three of the allowable acceleration, the allowable path error, and the filter time constant as a command value generation parameter set. That is, the parameter adjustment device 1 treats the command value generation parameter set including the above three as a target of parameter adjustment. However, not only the three parameters treated in the first embodiment but also all parameters affecting the interpolation points generated by the command value generation device 3 can be treated as targets of parameter adjustment.

The command value generation device 3 operates with setting values of the command value generation parameter set stored in advance in a setting value storage unit of the command value generation device 3. The setting values in the setting value storage unit can be rewritten by an external input from the parameter adjustment device 1.

Returning to FIG. 1, the parameter adjustment device 1 includes a feature calculation unit 11, an evaluation index calculation unit 12, an evaluation index information storage unit 13, a first optimal solution search unit 14, a candidate information storage unit 15, a preference information setting unit 16, a display unit 17, a second optimal solution search unit 18, and a post-adjustment command value generation parameter set storage unit 19.

The feature calculation unit 11 calculates a feature of machining by simulating an operation of a machine tool to be controlled based on the tool travel command generated by the command value generation device 3. Examples of the feature of machining include the amount of machining error which is a distance between the machining target shape 320 and the tool disposed at the position of the tool tip point, the velocity of the tool tip point, the acceleration of the tool tip point, the jerk of the tool tip point, the position of each of a plurality of drive shafts of the machine tool, the velocity of each of the plurality of drive shafts of the machine tool, the acceleration of each of the plurality of drive shafts of the machine tool, the jerk of each of the plurality of drive shafts of the machine tool, and an inverted position of each of the plurality of drive shafts of the machine tool.

Here, in a case where the entire workpiece is machined under one same condition, the process is performed as described above, but it is also possible to divide the workpiece into a plurality of portions, and to perform machining by changing the condition for each divided portion. In that case, the feature calculation unit 11 obtains the tool tip point by simulating the operation of the machine tool to be controlled based on the tool travel command generated by the command value generation device 3, and calculates the feature of machining which is information on machining at the tool tip point for each of one or more machined curved surfaces or for each of one or more machined edges included in the machining target shape 320. The one or more machined curved surfaces or machined edges included in the machining target shape 320 correspond to shape constituent elements.

The feature calculation unit 11 first performs a tool tip point estimation process of estimating the tool tip point, and then performs a feature calculation process of calculating the feature of machining at the tool tip point. The tool tip point estimation process and the feature calculation process will be sequentially described below.

### <Tool Tip Point Estimation Process>

The feature calculation unit 11 estimates the tool tip point by using result information obtained from a drive control unit of the machine tool as a target to be controlled to be driven actually or driven in simulation so as to follow the tool travel command generated by the command value generation device 3. In a case of using a result of the simulation, the feature calculation unit 11 simulates a behavior of the machine tool on a computer, and estimates an actual tool tip point from an interpolation point which is output of the command value generation device 3. Specifically, parameters of inertia, viscosity, and elasticity of the machine tool, a resonance frequency or an anti-resonance frequency caused by the inertia, the viscosity, and the elasticity, a parameter of backlash or lost motion at a time of axis inversion, a parameter of thermal displacement, a parameter of the amount of displacement caused by a reaction force at a time of machining, and/or the like are preset, and the operation of the machine tool is simulated. Here, the estimation accuracy of the tool tip point calculated in the simulation can be changed. In one example, in a case where the estimation accuracy corresponding to the drive shaft of the machine tool is required, position information of the drive shaft may be used as the tool tip point, and in a case where the estimation accuracy corresponding to the interpolation point is required, the interpolation point may be used as the tool tip point. In a case where a result of an actual operation is used, the feature calculation unit 11 operates an actual machine tool to acquire information corresponding to the tool tip point.

### <Feature Calculation Process>

The feature calculation unit 11 calculates, for each tool tip point obtained in the tool tip point estimation process, the feature of machining at the tool tip point in association with a machined curved surface or a machined edge in the machining target shape 320. Hereinafter, a method for calculating the amount of machining error, the velocity of the tool tip point, the acceleration of the tool tip point, the jerk of the tool tip point, the position of each of the plurality of drive shafts of the machine tool, the velocity of each of the plurality of drive shafts of the machine tool, the acceleration of each of the plurality of drive shafts of the machine tool, the jerk of each of the plurality of drive shafts of the machine tool, and an inverted position of each of the plurality of drive shafts of the machine tool, which are examples of the feature of machining, will be described.

The amount of machining error can be calculated as a shortest distance between the position of a cutting point corresponding to the tool tip point and a surface of the shape of the tool disposed in accordance with the position of the tool tip point and a tool direction. The position of the tool tip point is a position calculated from information obtained by simulating the behavior of the machine tool as a target to be controlled or a position obtained by operating the target to be controlled.

The velocity, the acceleration, and the jerk of the tool tip point can be calculated as follows. Regarding the tool tip points from the start point to the end point, when the position of an n-th tool tip point is denoted by PT(n) and the position of an (n+1)th tool tip point advanced by a time Δt of a predetermined control cycle is denoted by PT(n+1), a velocity VT(n) of the n-th tool tip point is calculated by dividing a distance between the positions PT(n+1) and PT(n) of the two tool tip points by the time Δt of the predetermined control cycle as expressed by the following formula (2).

$$\begin{matrix}Formula 2 & \\ VT ( n ) = \frac{PT ( n + 1 ) - PT ( n )}{Δ t} & ( 2 )\end{matrix}$$

Similarly, an acceleration AT(n) of the n-th tool tip point is calculated by dividing a difference between velocities VT(n+1) and VT(n) of the two tool tip points by the time Δt of the predetermined control cycle as expressed by the following formula (3).

$$\begin{matrix}Formula 3 & \\ AT ( n ) = \frac{VT ( n + 1 ) - VT ( n )}{Δ t} & ( 3 )\end{matrix}$$

Similarly, a jerk JT (n) of the n-th tool tip point is calculated by dividing a difference between accelerations AT(n+1) and AT(n) of the two tool tip points by the time Δt of the predetermined control cycle as expressed by the following formula (4).

$$\begin{matrix}Formula 4 & \\ JT ( n ) = \frac{AT ( n + 1 ) - AT ( n )}{Δ t} & ( 4 )\end{matrix}$$

The position, the velocity, the acceleration, and the jerk of each of the plurality of drive shafts of the machine tool can be calculated as follows. A position PM1(n) of a first drive shaft corresponding to the n-th tool tip point can be acquired from time-series data of operation information of the machine tool. The operation information is information indicating an operating state of the machine tool in operation. The operation information includes information obtained from the machine tool, a numerical control device that controls the machine tool, that is, the command value generation device 3, a sensor attached to the machine tool, or the like. In this example, the operation information includes position data of each of the plurality of drive shafts included in the machine tool.

When the position of the first drive shaft corresponding to the (n+1)th tool tip point advanced by the time Δt of the predetermined control cycle is denoted by PM1(n+1), a velocity VM1(n) of the first drive shaft corresponding to the n-th tool tip point at a time t is calculated by the following formula (5).

$$\begin{matrix}Formula 5 & \\ VM 1 ( n ) = \frac{PM 1 ( n + 1 ) - PM 1 ( n )}{Δ t} & ( 5 )\end{matrix}$$

Similarly, when the velocity of the first drive shaft corresponding to the (n+1)th tool tip point advanced by the time Δt of the predetermined control cycle is denoted by VM1(n+1), an acceleration AM1(n) of the first drive shaft corresponding to the n-th tool tip point is calculated by the following formula (6).

$$\begin{matrix}Formula 6 & \\ AM 1 ( n ) = \frac{VM 1 ( n + 1 ) - VM 1 ( n )}{Δ t} & ( 6 )\end{matrix}$$

Similarly, when the acceleration of the first drive shaft corresponding to the (n+1)th tool tip point advanced by the time Δt of the predetermined control cycle is denoted by AM1(n+1), a jerk JM1(n) of the first drive shaft corresponding to the n-th tool tip point is calculated by the following formula (7).

$$\begin{matrix}Formula 7 & \\ JM 1 ( n ) = \frac{AM 1 ( n + 1 ) - AM 1 ( n )}{Δ t} & ( 7 )\end{matrix}$$

Also for each of the other drive shafts than the first drive shaft, the position, the velocity, the acceleration, and the jerk can be calculated by a method similar to that described above.

An inverted position of each of the plurality of drive shafts of the machine tool can be calculated as follows. By the above-described method, the velocity VM1(n) of the first drive shaft corresponding to the n-th tool tip point and the velocity VM1(n+1) of the first drive shaft corresponding to the (n+1)th tool tip point advanced by the time Δt of the predetermined control cycle are calculated. At that time, the sign of the velocity VM1(n) is compared with the sign of the velocity VM1(n+1), and a position corresponding to a time when the sign is inverted can be obtained as an inverted position of the first drive shaft. The inverted position of each of the drive shafts other than the first drive shaft can be obtained by a method similar to that described above.

The feature calculation unit 11 associates the feature of machining with a machined curved surface or a machined edge in the machining target shape 320. In one example, in the machining target shape 320, an ID number which is identification information for identifying each of the machined curved surfaces and the machined edges is allocated in advance for each piece of information on the machined curved surfaces and the machined edges, and thereby the feature of machining regarding the corresponding ID number can be specified.

The feature calculation unit 11 outputs the feature of machining calculated as described above to the evaluation index calculation unit 12. In a case where the entire workpiece is machined under one condition, the feature calculation unit 11 outputs the feature of machining for the machining target shape 320 to the evaluation index calculation unit 12. In addition, in a case where the entire workpiece is divided into a plurality of portions and machining is performed under different conditions for each divided portion, the feature calculation unit 11 divides the feature of machining for each machined curved surface or each machined edge in the machining target shape 320, and outputs the features of machining to the evaluation index calculation unit 12.

The evaluation index calculation unit 12 calculates one or more evaluation index values for evaluating a machining result from the feature of machining calculated by the feature calculation unit 11. In the following description, as an example, a case will be described where the machining result is a machining time which is a cycle time, machining accuracy which is shape accuracy of a machined surface, and surface quality which is surface accuracy of the machined surface. The machining time, the machining accuracy, and the surface quality are in a trade-off relationship with each other.

For an evaluation index value Qt regarding the machining time, in one example, it is possible to use a deceleration rate of the velocity of the tool tip point calculated from the result information with respect to a command velocity described in the machining program 310, and the evaluation index value Qt is calculated by the following formula (8).

$$\begin{matrix}Formula 8 & \\ Qt ( ○ ) = \frac{1}{{N}_{○}} {\sum }_{i = 1}^{{N}_{○}} \frac{{F}_{c} ( i ) - {F}_{○} ( i )}{{F}_{c} ( i )} & ( 8 )\end{matrix}$$

Here, open circles “O” each represent a machined curved surface or a machined edge included in the machining target shape 320. In the case of the machining target shape 320 in FIGS. 2 to 4, the open circles “O” represent the machined curved surfaces S1 to S3 and the machined edges E1 and E2. N represents the number of data points of the tool tip point corresponding to each of the machined curved surfaces and the machined edges, F_{c} represents the command velocity, and F represents the velocity of the tool tip point.

According to the formula (8), the better the velocity F of the tool tip point matches the command velocity F_{c}, the smaller the evaluation index value Qt of the machining time becomes. That is, it can be said that in the first embodiment, the smaller the evaluation index value Qt, the more excellent the command value generation parameter set in the parameter adjustment device 1 in terms of the machining time. However, the evaluation index value Qt may be any value as long as the machining time can be evaluated, and is not limited to the value specified by the formula (8). In one example, the evaluation index value Qt may be the number of data points N itself of the tool tip point corresponding to each of specific machined curved surfaces and machined edges, or a time calculated by multiplying the number of data points N by an execution unit may be used.

In the formula (8), the velocity of the tool tip point is used to calculate the evaluation index value Qt of the machining time, but it is also possible to use an average value of the velocity of the tool tip point, a maximum value of the velocity of the tool tip point, an average value of the velocity of each of the plurality of drive shafts of the machine tool, or a maximum value of the velocity of each of the plurality of drive shafts of the machine tool.

In general, in a case where the machining time is shortened, the average value of the acceleration, the maximum value of the acceleration, the average value of the jerk, and the maximum value of the jerk tend to increase. Therefore, the average value of the acceleration of the tool tip point, the maximum value of the acceleration thereof, the average value of the jerk thereof, the maximum value of the jerk thereof, the average value of the acceleration of each of the plurality of drive shafts of the machine tool, the maximum value of the acceleration thereof, the average value of the jerk thereof, the maximum value of the jerk thereof, or the like can also be used as the evaluation index value Qt of the machining time. However, in that case, it is determined that the larger the evaluation index value Qt is, the more excellent the command value generation parameter set in the parameter adjustment device 1 is in terms of the machining time.

For an evaluation index value Qa regarding the machining accuracy, in one example, it is possible to use an average value of the amount of machining error which is a distance between the machining target shape 320 and the tool disposed at the position of the tool tip point, and the evaluation index value Qa is calculated by the following formula (9).

$$\begin{matrix}Formula 9 & \\ Qa ( ○ ) = \frac{1}{{N}_{○}} {\sum }_{i = 1}^{{N}_{○}} {e}_{○} ( i ) & ( 9 )\end{matrix}$$

Here, open circles “O” each represent a machined curved surface or a machined edge included in the machining target shape 320. In the case of the machining target shape 320 in FIGS. 2 to 4, the open circles “O” represent the machined curved surfaces S1 to S3 and the machined edges E1 and E2. N represents the number of data points of the tool tip point corresponding to each of the machined curved surfaces and the machined edges, and e represents the amount of machining error calculated as the feature of machining.

According to the formula (9), the smaller the amount of machining error e is, the smaller the evaluation index value Qa of the machining accuracy is. That is, it can be said that, in the first embodiment, the smaller the evaluation index value Qa is, the more excellent the command value generation parameter set in the parameter adjustment device 1 is in terms of the machining accuracy. However, the evaluation index value Qa may be any value as long as the machining accuracy can be evaluated, and is not limited to the value specified by the formula (9). In one example, the evaluation index value Qa may be a value indicating the degree of mechanical vibration or followability of the tool.

In the formula (9), the amount of machining error corresponding to each of the machined curved surfaces and the machined edges is used to calculate the evaluation index value Qa of the machining accuracy, but it is also possible to use the maximum value or the minimum value of the amount of machining error corresponding to each of the specific machined curved surfaces and machined edges.

In general, in a case where the machining accuracy deteriorates, the average value of the acceleration, the maximum value of the acceleration, the average value of the jerk, and the maximum value of the jerk tend to increase. Therefore, the maximum value and the minimum value of the acceleration of the tool tip point, the maximum value and the minimum value of the jerk of the tool tip point, the maximum value and the minimum value of the acceleration of each of the plurality of drive shafts of the machine tool, the maximum value and the minimum value of the jerk of each of the plurality of drive shafts of the machine tool, or the like can also be used as the evaluation index value Qa of the machining accuracy.

Furthermore, it may be determined that the larger the evaluation index value Qa is, the more excellent the command value generation parameter set in the parameter adjustment device 1 is in terms of the machining accuracy.

For an evaluation index value Qq regarding the surface quality, in one example, it is possible to use a variance value of the amount of machining error which is the distance between the machining target shape 320 and the tool disposed at the position of the tool tip point, and the evaluation index value Qq is calculated by the following formula (10).

$$\begin{matrix}Formula 10 & \\ Qq ( ○ ) = \frac{1}{{N}_{○}} {\sum }_{i = 1}^{{N}_{○}} {( {e}_{○} ( i ) - {e}_{a , ○} )}^{2} & ( 10 )\end{matrix}$$

Here, open circles “O” each represent a machined curved surface or a machined edge included in the machining target shape 320. In the case of the machining target shape 320 in FIGS. 2 to 4, the open circles “O” represent the machined curved surfaces S1 to S3 and the machined edges E1 and E2. N represents the number of data points of the tool tip point corresponding to each of the machined curved surfaces and the machined edges, e represents the amount of machining error calculated as the feature of machining, and eₐ represents an average value of the amount of machining error.

According to the formula (10), the smaller the variance of the amount of machining error e is, the smaller the evaluation index value Qq of the surface quality is. That is, it can be said that, in the first embodiment, the smaller the evaluation index value Qq is, the more excellent the command value generation parameter set in the parameter adjustment device 1 is in terms of the surface quality. However, the evaluation index value Qq may be any value as long as the surface quality can be evaluated, and is not limited to the value specified by the formula (10). In one example, the evaluation index value Qq may be a value indicating the degree of mechanical vibration.

In the formula (10), the difference between the amount of machining error corresponding to each of the machined curved surfaces and the machined edges and the average value of machining errors is used to calculate the evaluation index value Qq of the surface quality, but it is also possible to use a difference between the maximum value and the minimum value of the amount of machining error corresponding to each of the specific machined curved surfaces and machined edges, a difference between the maximum value and the minimum value of the acceleration of the tool tip point, a difference between the maximum value and the minimum value of the jerk of the tool tip point, a difference between the maximum value and the minimum value of the acceleration of each of the plurality of drive shafts of the machine tool, a difference between the maximum value and the minimum value of the jerk of each of the plurality of drive shafts of the machine tool, and the like.

Furthermore, it may be determined that the larger the evaluation index value Qq is, the more excellent the command value generation parameter set in the parameter adjustment device 1 is in terms of the surface quality.

Here, three evaluation indexes regarding the machining time, the machining accuracy, and the surface quality are calculated, but any one or more evaluation indexes among those regarding the machining time, the machining accuracy, and the surface quality may be calculated in line with a worker's preference.

The evaluation index information storage unit 13 stores evaluation index information in which the evaluation index values regarding the machining time, the machining accuracy, and the surface quality calculated by the evaluation index calculation unit 12 are associated with the command value generation parameter set for each of the machined curved surfaces and the machined edges in the machining target shape 320. Note that the evaluation index information may include a corresponding feature of machining, in addition to the evaluation index values regarding the machining time, the machining accuracy, and the surface quality, and the command value generation parameter set.

The first optimal solution search unit 14 infers evaluation index values corresponding to a first search command value generation parameter set, which is a first command value generation parameter set for search, by using a first learning result for inferring evaluation index values from the command value generation parameter set that has been learned by using the command value generation parameter set and the evaluation index values, and searches, by using a result of the inference, for command value generation parameter set candidates which are a plurality of command value generation parameter sets that simultaneously optimize the respective evaluation index values. In a case of searching for a plurality of command value generation parameter set candidates, the search is made for command value generation parameter set candidates that simultaneously optimize the respective evaluation index values so that there is a difference in balance among the evaluation index values in a trade-off relationship. In one example, the rate of each evaluation index value to the sum of the evaluation index values of the machining time, the machining accuracy, and the surface quality is the balance. In one example, the fact that at least one evaluation index value of the three evaluation index values of the command value generation parameter set candidates is deviated by a predetermined rate or more from the corresponding evaluation index value of the other command value generation parameter set candidates means that there is a difference in the balance among the evaluation index values. In this example, the first optimal solution search unit 14 searches for one or more command value generation parameter set candidates simultaneously minimizing the respective evaluation index values. Here, “simultaneously minimizing” is finding a solution that deteriorates another objective function when improving one evaluation index value among three evaluation index values in a trade-off relationship.

A learning process of learning a relationship between the command value generation parameter set and the evaluation index values and a search process of searching for a parameter set by using a learning result will be described below.

### <Learning Process>

In the learning process, the first optimal solution search unit 14 receives the evaluation index values regarding the machining time, the machining accuracy, and the surface quality, and a parameter range as inputs, learns a relationship between the command value generation parameter set and the evaluation index values calculated by the evaluation index calculation unit 12, and outputs a learning result. That is, the first optimal solution search unit 14 generates the first learning result for inferring the evaluation index values from the command value generation parameter set by using learning data including the command value generation parameter set and the evaluation index values regarding the machining time, the machining accuracy, and the surface quality.

Specifically, a neural network that receives the command value generation parameter set as an input and outputs the evaluation index values is configured, and the first optimal solution search unit 14 performs learning by updating a weight coefficient of the neural network. In a case where learning is performed by updating the weight coefficient, the neural network outputs favorable estimated values of the evaluation index values corresponding to the command value generation parameter set. The first optimal solution search unit 14 uses the neural network to obtain a function that receives a command value generation parameter set as an input and outputs evaluation index values, thereby obtaining, as a learning result, the first learning result which is a relational formula between the command value generation parameter set and the evaluation index values.

The first optimal solution search unit 14 selects, from a defined parameter range, a command value generation parameter set for executing the next machining operation in the machining target shape 320 and outputs the selected command value generation parameter set. When selecting the next command value generation parameter set, the first optimal solution search unit 14 may select a command value generation parameter set indicating excellent evaluation index values on the basis of the learning result, or may sequentially select respective command value generation parameter sets from grid points located at equal intervals. The first optimal solution search unit 14 has a function of updating a function for calculating evaluation index values regarding the machining time, the machining accuracy, and the surface quality on the basis of the command value generation parameter set.

Here, a process will be described in which the operation of the first optimal solution search unit 14 is executed four times and the command value generation parameter sets, up to a fourth set thereof, are evaluated. A first command value generation parameter set, which is a command value generation parameter set as a first set, is denoted by Pr1, a second command value generation parameter set, which is a command value generation parameter set as a second set, is denoted by Pr2, a third command value generation parameter set, which is a command value generation parameter set as a third set, is denoted by Pr3, and a fourth command value generation parameter set, which is a command value generation parameter set as a fourth set, is denoted by Pr4. Each of the four command value generation parameter sets includes three parameters of allowable acceleration, allowable path error, and filter time constant.

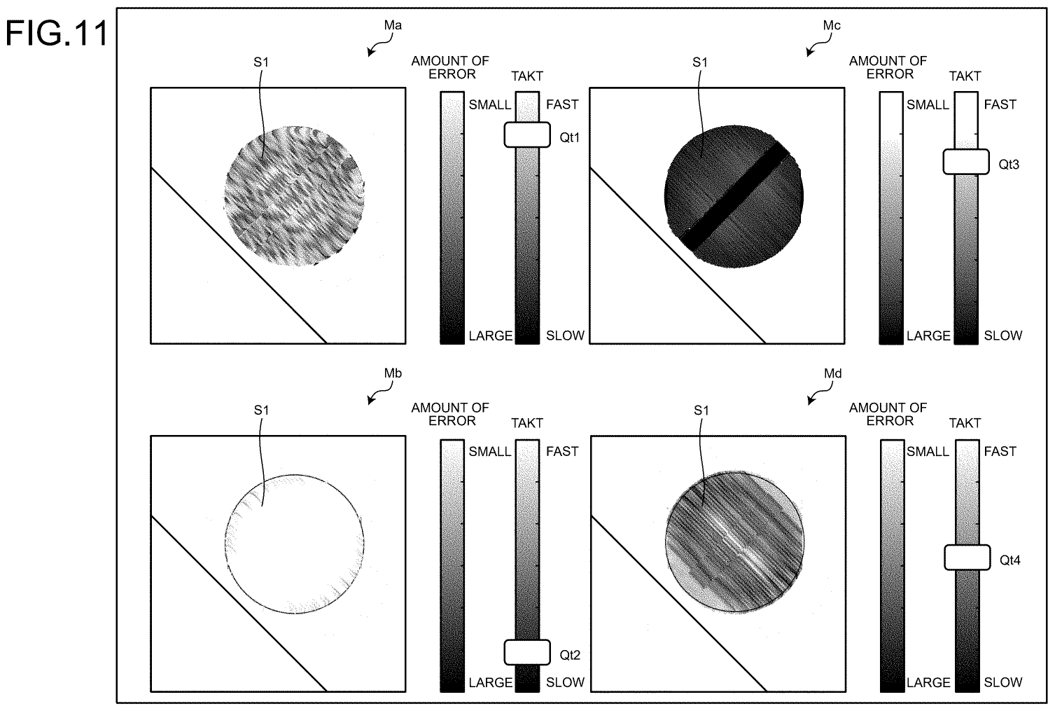

FIG. 11 is a diagram illustrating examples of mapping diagrams of the amounts of machining error of a machined curved surface in the machining target shape in a case of performing machining operations generated on the basis of the first to fourth command value generation parameter sets and relationships thereof with machining times. FIG. 11 illustrates mapping diagrams of the amounts of machining error of the machined curved surface S1. A mapping diagram Ma illustrates the amount of machining error and a machining time of the machined curved surface S1 in a case where the first command value generation parameter set is used. A mapping diagram Mb illustrates the amount of machining error and a machining time of the machined curved surface S1 in a case where the second command value generation parameter set is used. A mapping diagram Mc illustrates the amount of machining error and a machining time of the machined curved surface S1 in a case where the third command value generation parameter set is used. A mapping diagram Md illustrates the amount of machining error and a machining time of the machined curved surface S1 in a case where the fourth command value generation parameter set is used. The distribution of the amount of machining error on the machined curved surface S1 indicates the surface quality. It is considered that the surface quality is high in a case where the amount of machining error is uniform on the machined curved surface S1, and the surface quality is low in a case where the amount of machining error is not uniform thereon. The hatching attached to the machined curved surface S1 of each of these mapping diagrams Ma to Md indicates the amount of error, and a legend of the amount of error is indicated in the “amount of error” on the right side of each of the mapping diagrams Ma to Md. The machining time is indicated by a slide bar at “takt” on the right side of each of the mapping diagrams Ma to Md.

When receiving evaluation index values Qt1, Qa1, and Qq1 regarding the machining time, the machining accuracy, and the surface quality for the machined curved surface S1 in the machining target shape 320 obtained by a result of the machining operation in a case where the command value generation parameter is the first command value generation parameter set Pr1, the first optimal solution search unit 14 changes the first command value generation parameter set Pr1 to the second command value generation parameter set Pr2. At that time, the second command value generation parameter set Pr2 may be selected on the basis of a result of the machining operation using the first command value generation parameter set Pr1, or the second command value generation parameter set Pr2 may be selected as determined in advance regardless of the result of the machining operation using the first command value generation parameter set Pr1.

The first optimal solution search unit 14 receives evaluation index values Qt2 to Qt4, Qa2 to Qa4, and Qq2 to Qq4 corresponding to the second to fourth command value generation parameter sets Pr2 to Pr4 in a procedure similar to that in the case of the first command value generation parameter set Pr1.

In a case where the feature of machining illustrated in FIG. 11 is obtained, the evaluation index value Qt1 is smallest among the four evaluation index values Qt1 to Qt4 in terms of the machining time. That is, it can be said that the first command value generation parameter set Pr1 is a command value generation parameter set that gives priority to the machining time.

In terms of the machining accuracy, the evaluation index value Qa2 is smallest among the four evaluation index values Qa1 to Qa4. That is, it can be said that the second command value generation parameter set Pr2 is a command value generation parameter set that gives priority to the machining accuracy.

In terms of the surface quality, the evaluation index value Qq3 is smallest among the four evaluation index values Qq1 to Qq4. That is, it can be said that the third command value generation parameter set Pr3 is a command value generation parameter set that gives priority to the surface quality.

It can be said that the fourth command value generation parameter set Pr4 is a balanced command value generation parameter set in terms of all of the machining time, the machining accuracy, and the surface quality.

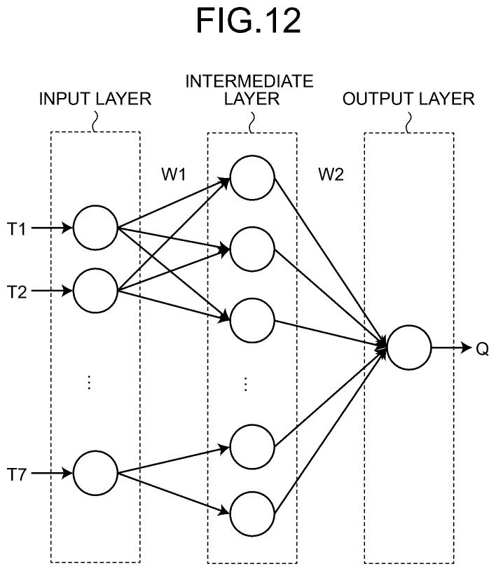

As described above, the first optimal solution search unit 14 repeatedly performs the operation of acquiring the evaluation index values corresponding to the command value generation parameters. The first optimal solution search unit 14 performs a learning operation using a neural network with the command value generation parameters and the evaluation index values corresponding to the command value generation parameters obtained by repeatedly performing the above operation, as learning data. FIG. 12 is a diagram illustrating an example of a neural network used in a learning process of the first embodiment. The neural network includes an input layer, an intermediate layer, and an output layer. A command value generation parameter set is input to the input layer on a leftmost side, and evaluation index values are output from the output layer on a rightmost side. Although all the weight coefficients from each node of the input layer to each node of the intermediate layer can be independently set, these weight coefficients are all expressed as the same weight coefficient W1 in FIG. 12. Similarly, although all the weight coefficients from each node of the intermediate layer to each node of the output layer can be independently set, these weight coefficients are all expressed as the same weight coefficient W2 in FIG. 12.

An output value of each node of the input layer is multiplied by the weight coefficient W1, and a linear combination as a result obtained by the multiplication is input to each node of the intermediate layer. An output value of each node of the intermediate layer is multiplied by the weight coefficient W2, and a linear combination as a result obtained by the multiplication is input to each node of the output layer. In each node of each layer, in one example, the output value may be calculated from the input value by a nonlinear function such as a sigmoid function. In the input layer and the output layer, output values may be linear combinations of input values.

The first optimal solution search unit 14 calculates the weight coefficient W1 and the weight coefficient W2 of the neural network by using the command value generation parameter set and the evaluation index values. The weight coefficient W1 and the weight coefficient W2 of the neural network can be calculated by using backpropagation or gradient descent. In one example, the neural network learns by adjusting the weight coefficient W1 and the weight coefficient W2 such that a result output from the output layer after inputting the command value parameter set to the input layer approximates the evaluation index values. However, the method for calculating the weight coefficient W1 and the weight coefficient W2 is not limited to the above-described method as long as the weight coefficients of the neural network can be obtained by the calculation method.

When the weight coefficients W1 and W2 of the neural network are determined, a relational formula between the command value generation parameters and the evaluation index values is obtained. So far, the example has been depicted in which learning with the use of the three-layer neural network is performed. The learning with the use of the neural network is not limited to the above example.

By the above operation, the function that receives the command value generation parameter set as an input and outputs the evaluation index values, the function being a relational formula by the neural network, is obtained as the first learning result. The first learning result is a learning result for inferring the evaluation index values from the command value generation parameters.

Use of the first learning result makes it possible to obtain the evaluation index values Qt, Qa, and Qq regarding the machining time, the machining accuracy, and the surface quality corresponding to a new command value generation parameter set without executing the machining operation on the new command value generation parameter set.

In the first embodiment, the neural network is used to construct the relational formula between the command value generation parameter set and the evaluation index values. However, a method other than the neural network may be used as long as the relationship between the command value generation parameter set and the evaluation index values can be obtained. In one example, in order to obtain the relationship between the command value generation parameter set and the evaluation index values, a simple function such as a quadratic polynomial may be used, or a probability model such as a Gaussian process model may be used.

The prediction accuracy of the first learning result depends on the number of repetitions of the operation of acquiring the evaluation index values corresponding to the command value generation parameter set. In a case where the number of repetitions is small, the first learning result can be obtained in a short time, but errors included in the evaluation index values predicted from the command value generation parameter set tend to increase. On the other hand, in a case where a sufficient number of repetitions is ensured, the errors included in the evaluation index values predicted from the command value generation parameter set decreases, but it tends to take a long time to obtain an accurate first learning result.

When performing the learning operation, regarding the vicinity of a boundary in the distribution of the evaluation index values where the evaluation index values regarding the machining time, the machining accuracy, and the surface quality is maximized or minimized, it is preferable to ensure a sufficient number of repetitions for the operation of acquiring the evaluation index values corresponding to the command value generation parameter set. On the other hand, regarding a region other than the vicinity of the boundary, it is not necessary to ensure a sufficient number of repetitions for the operation of acquiring the evaluation index values corresponding to the command value generation parameters. In that case, it is only required to acquire the evaluation index values in a wide range within the designated parameter range, and there is no problem even if the number of repetitions is small.

In this example, the learning process is performed for each machined curved surface or each machined edge in the machining target shape 320, but the learning process may be simultaneously performed for a plurality of machined curved surfaces and machined edges. In the examples of the machining target shape 320 illustrated in FIGS. 2 to 4, in a case where the machined curved surface S1 and the machined curved surface S2, as well as the machined edge E1 surrounded by the machined curved surface S1 and the machined curved surface S2 are simultaneously machined, a linear combination of the evaluation index values of the machined curved surfaces S1 and S2 and the machined edge E1 is defined as a new evaluation formula Q′. When an evaluation index value of the machined curved surface S1 is denoted by Q(S1), an evaluation index value of the machined curved surface S2 is denoted by Q(S2), an evaluation index value of the machined edge E1 is denoted by Q(E1), and a_{S1}, a_{S2}, and a_{E1} are coefficients, the new evaluation formula Q′ is expressed by the following formula (11).

$$\begin{matrix}Formula 11 & \\ {Q}_{□}^{′} = {a}_{S 1} {Q}_{□} ( S 1 ) + {a}_{S 2} {Q}_{□} ( S 2 ) + {a}_{E 1} {Q}_{□} ( E 1 ) & ( 11 )\end{matrix}$$

Here, open squares each represent the machining time, the machining accuracy, or the surface quality to be evaluated. That is, the evaluation formula Q′ represents evaluation index values of a plurality of machined curved surfaces and machined edges included in the machining target shape 320, and the examples in FIGS. 2 to 4 illustrate the evaluation index values of any of the machining time, the machining accuracy, and the surface quality to be evaluated of the machined curved surfaces S1 to S3 and the machined edges E1 and E2. Consequently, the learning process can be performed even in a case where a shape constituent element including a plurality of machined curved surfaces or machined edges is machined with one command value generation parameter set.

The learning data used when the first optimal solution search unit 14 performs the learning process is data on a target to be controlled used by the feature calculation unit 11 for feature calculation.

### <Search Process>

In the search process, the first optimal solution search unit 14 infers the evaluation index values corresponding to a search command value generation parameter set, which is a command value generation parameter set for search, by using the first learning result for inferring the evaluation index values from the command value generation parameter set. In addition, by using a result of the inference, the first optimal solution search unit 14 searches for a command value generation parameter set candidate which is a command value generation parameter set that simultaneously optimizes the respective evaluation index values. In the case where the entire workpiece is machined under one condition, the first optimal solution search unit 14 searches for a command value generation parameter set candidate for the machining target shape 320. On the other hand, in the case where the entire workpiece is divided into a plurality of portions and machined under conditions different for each divided portion, the first optimal solution search unit 14 searches for a command value generation parameter set candidate for each machined curved surface or each machined edge in the machining target shape 320. The command value generation parameter set candidate may be one command value generation parameter set that simultaneously optimizes the respective evaluation index values, or may be a plurality of command value generation parameter sets. The search command value generation parameter set used by the first optimal solution search unit 14 corresponds to the first search command value generation parameter set.

That is, on the basis of the first learning result which is a relational formula between the command value generation parameters and the evaluation index values, the first optimal solution search unit 14 obtains, by numerical calculation, one or more command value generation parameter set candidates which are command value generation parameter sets that differ in the balance among the evaluation index values regarding the machining time, the machining accuracy, and the surface quality, and simultaneously minimize the evaluation index values regarding the machining time, the machining accuracy, and the surface quality within a predetermined command value generation parameter range, for the machining target shape 320 or for each machined curved surface or each machined edge in the machining target shape 320. In one example, the first optimal solution search unit 14 obtains the command value generation parameter set by using an optimization algorithm such as grid search, random search, Newton's method, Bayesian optimization, or evolutionary computation. Examples of evolutionary computation include non-dominated sorting genetic algorithms II (NSGA-II), adaptive geometry estimation based a multiobjective evolutional algorithm (AGE-MOEA), AGE-MOEA2, and reference point based NSGA-II (R-NSGA-II). The command value generation parameter set is a search command value generation parameter set. Then, by inputting the search command value generation parameter set to the first learning result, the evaluation index values regarding the machining time, the machining accuracy, and the surface quality are obtained, and the search command value generation parameter set is associated with the evaluation index values. Combinations of search command value generation parameters and corresponding evaluation index values are classified by using the evaluation index values regarding the machining time, the machining accuracy, and the surface quality, and a command value generation parameter set corresponding to best evaluation index values among the classified ones is employed as a command value generation parameter candidate.

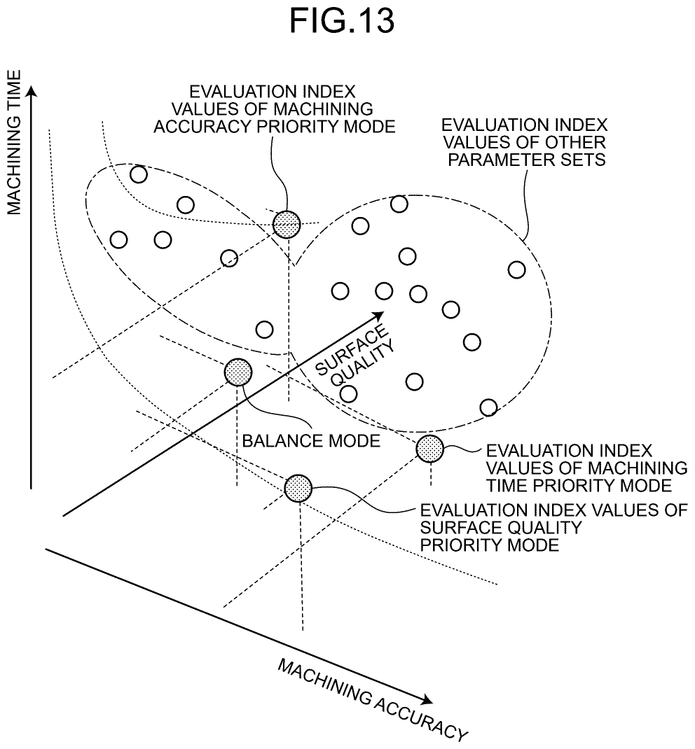

FIG. 13 is a diagram illustrating examples of command value generation parameter sets for a machined curved surface searched for by the first optimal solution search unit in the first embodiment. FIG. 13 illustrates a distribution diagram in which combinations of evaluation index values regarding the machining time, the machining accuracy, and the surface quality corresponding to command value generation parameter sets are plotted in an orthogonal coordinate system including, as axes, evaluation index values regarding the machining time, the machining accuracy, and the surface quality. This example also illustrates an example of a result of a search for the command value generation parameter set for the machined curved surface S1 in the machining target shape 320 in FIGS. 2 to 4. The command value generation parameter set candidates extracted in FIG. 13 can be categorized into four modes: a machining time priority mode which is a command value generation parameter set candidate that gives priority to the machining time among the three evaluation index values of the machining time, the machining accuracy, and the surface quality, and reduces the machining time; a machining accuracy priority mode which is a command value generation parameter set candidate that gives priority to the machining accuracy and improves the machining accuracy; a surface quality priority mode which is a command value generation parameter set candidate that gives priority to the surface quality and improves the surface quality; and a balance mode which is a command value generation parameter set candidate that improves the three evaluation indexes in a well-balanced manner. The evaluation index values other than these four modes are those corresponding to other command value generation parameter sets.

FIG. 13 illustrates an example in which the command value generation parameter set candidates are extracted one by one for each of the four categories of the machining time priority mode, the machining accuracy priority mode, the surface quality priority mode, and the balance mode. However, it is not necessary to extract the command value generation parameter sets corresponding to all the categories, and it is only required to extract a command value generation parameter set corresponding to at least one category. A plurality of command value generation parameter sets corresponding to one category may be extracted.

As described above, the first optimal solution search unit 14 has a function of searching combinations of search command value generation parameter sets and evaluation index values obtained when the search command value generation parameter sets are input to the first learning result, for a command value generation parameter set candidate including any one of: a command value generation parameter set that, under a condition that any one of the evaluation index values of the machining time, the machining accuracy, and the surface quality is preferentially improved within a predetermined command value generation parameter range, optimizes the remaining two of the evaluation index values; and a command value generation parameter set that improves the evaluation index values of the machining time, the machining accuracy, and the surface quality in a well-balanced manner within the predetermined command value generation parameter range. In the case where the entire workpiece is machined under one condition, the search for the command value generation parameter set candidate is made for the machining target shape 320. In the case where the entire workpiece is divided into a plurality of portions and machined under different conditions for each divided portion, the search for the command value generation parameter set candidate is made for each machined curved surface or each machined edge. The first optimal solution search unit 14 can simultaneously perform a learning process and an inference process, as well.

Returning to FIG. 1, the candidate information storage unit 15 stores candidate information which is information in which the command value generation parameter set candidate extracted by the first optimal solution search unit 14 is associated with the evaluation index values and the feature of machining calculated by the feature calculation unit 11. In one example, in a case where a plurality of command value generation parameter set candidates are extracted, the plurality of command value generation parameter set candidates are associated with the respective evaluation index values and the features of machining calculated by the feature calculation unit 11, and are stored in the candidate information storage unit 15. In the case where the entire workpiece is machined under one condition, the candidate information is information in which the command value generation parameter set candidate is associated with the evaluation index values and the feature of machining for each machining target shape 320. In the case where the entire workpiece is divided into a plurality of portions and machined under different conditions for each divided portion, the candidate information is information in which the command value generation parameter set candidate is associated with the evaluation index values and the feature of machining for each machined curved surface or each machined edge. Note that the evaluation index values in all the command value generation parameter sets obtained by the learning process and the search process performed by the first optimal solution search unit 14 and the features of machining calculated by the feature calculation unit 11 may be stored in the candidate information storage unit 15.

The preference information setting unit 16 performs control to display, on the display unit 17, the feature of machining calculated when the command value generation parameter set candidate is set on the command value generation device 3 that generates the tool travel command and the command value generation device 3 operates, and the respective evaluation index values in association with each other. In the case where the entire workpiece is machined under one condition, the preference information setting unit 16 displays, on the display unit 17, the feature of machining of the command value generation parameter set candidate and the respective evaluation index values in association with each other for the machining target shape 320. In the case where the entire workpiece is divided into a plurality of portions and machined under different conditions for each divided portion, the preference information setting unit 16 displays, on the display unit 17, the feature of machining of the command value generation parameter set candidate and the respective evaluation index values in association with each other for each machined curved surface or each machined edge. In addition, the actual machine tool may be operated in accordance with the command value generation parameter set, and the workpiece of the machining target shape 320 that has been actually machined may be associated with the respective evaluation index values and presented to the worker, or image data of the workpiece of the machining target shape 320 that has been machined may be associated with the respective evaluation index values and displayed on the display unit 17.

In addition, the preference information setting unit 16 sets preference information for the respective evaluation index values of the command value generation parameter set candidate selected by the worker among the feature of machining and the respective evaluation index values displayed on the display unit 17. In one example, the preference information setting unit 16 sets, as the preference information, the respective evaluation index values of the command value generation parameter set candidate selected and adjusted by the worker among the feature of machining and the respective evaluation index values displayed on the display unit 17. In the case where the entire workpiece is machined under one condition, the preference information is set for the machining target shape 320. In the case where the entire workpiece is divided into a plurality of portions and machined under different conditions for each divided portion, the preference information is set for each machined curved surface or each machined edge in the machining target shape 320. Note that a display control unit corresponds to the preference information setting unit 16.

At the time of the process performed by the first optimal solution search unit 14, the preference information may be set in advance by the worker as much as possible. At that time, the command value generation parameter set candidate reflecting preset preference information is extracted by the first optimal solution search unit 14, and therefore the preference information setting unit 16 may set preference information of an item other than a preset item, or the preference information setting unit 16 may reset the preset item.

In one example, the preference information setting unit 16 displays, on the display unit 17, the command value generation parameter set candidates stored in the candidate information storage unit 15, and the evaluation index values and the features of machining associated with the command value generation parameter set candidates. In this example, the command value generation parameter set candidates are those of the machining time priority mode, the machining accuracy priority mode, the surface quality priority mode, and the balance mode. The worker selects one command value generation parameter set candidate from four categories of the machining time priority mode, the machining accuracy priority mode, the surface quality priority mode, and the balance mode on the basis of the feature of machining obtained by the feature calculation unit 11 via an input unit (not illustrated). In addition, the worker sets worker preference information with reference to the feature of machining and the evaluation index values regarding the machining time, the machining accuracy, and the surface quality obtained from the selected command value generation parameter set candidate via the input unit. The preference information is evaluation index values set by the worker, that is, evaluation index values regarding the machining time, the machining shape, and the surface quality possessed by the worker. It can be said that the preference information is information indicating which of the machining time, the machining accuracy, and the surface quality the worker regards as important when performing machining. In the case where the entire workpiece is machined under one condition, the worker sets the preference information regarding the machining time, the machining accuracy, and the surface quality for the machining target shape 320. In the case where the entire workpiece is divided into a plurality of portions and machined under different conditions for each divided portion, the worker sets the preference information regarding the machining time, the machining accuracy, and the surface quality for each machined curved surface or each machined edge. In the latter case, the worker adjusts the evaluation index values of the machining time, the machining accuracy, and the surface quality regarding the selected command value generation parameter set candidate for a machined curved surface or a machined edge to be a target. This adjustment depends on a worker's preference. The preference information setting unit 16 uses the adjusted evaluation index values of the machining time, the machining accuracy, and the surface quality as the preference information, and sets the preference information for the machined curved surface or the machined edge to be a target.

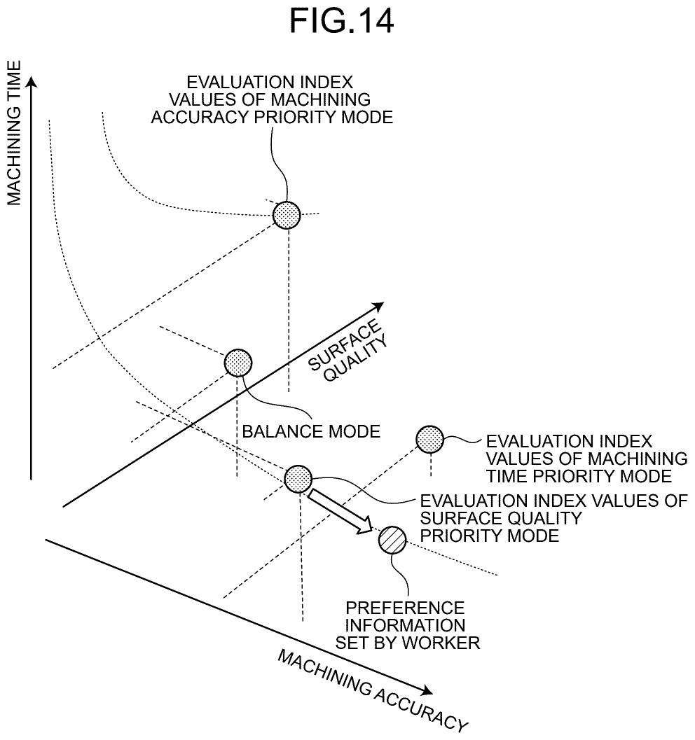

In the examples illustrated in FIGS. 2 to 4, the machining target shape 320 includes the machined curved surfaces S1 to S3 and the machined edges E1 and E2, and the worker selects a command value generation parameter set candidate closest to the worker's preference for each of the machined curved surfaces S1 to S3 and the machined edges E1 and E2. FIG. 14 is a diagram illustrating an example of setting of preference information by the worker for one command value generation parameter set candidate selected from among categories of the machining time priority mode, the machining accuracy priority mode, the surface quality priority mode, and the balance mode for the machined curved surface illustrated in FIG. 13. Similarly to FIG. 13, FIG. 14 also illustrates evaluation index values for the machined curved surface S1. As illustrated in FIG. 14, as a specific process, when the worker indicates a position on the machined curved surface S1 in the machining target shape 320 in advance, the evaluation index values of the current machining time, machining accuracy, and surface quality for the indicated machined curved surface S1 are displayed on the display unit 17. In one example, the evaluation index values of the machining time, the machining accuracy, and the surface quality associated with the command value generation parameter set candidate selected by the worker are displayed. The worker corrects the displayed evaluation index values of the current machining time, machining accuracy, and surface quality via the input unit. The preference information setting unit 16 sets, as the preference information, the evaluation index values of the machining time, the machining accuracy, and the surface quality corrected by the worker for the machined curved surface S1. In the example in FIG. 14, the surface quality priority mode is selected by the worker, and adjustment is performed so as to maintain the surface quality and shorten the machining time.

At that time, regarding a method for designating a machined curved surface, the worker is only required to select the position on the machined curved surface in the machining target shape 320 with a pointing device such as a mouse or a touch panel, in one example. The indicated position may be one specific point or a plurality of points, or a continuous region may be indicated.

A method for correcting an evaluation index value may be, in one example, input of a numerical value, or may be adjustment of a current setting value by using a graphical user interface (GUI) button such as a button or a bar. At that time, a range of inputtable numerical values or a range of adjustable setting values may be set from the maximum value and the minimum value of the evaluation index values corresponding to the command value generation parameter set candidates stored in the candidate information storage unit 15 of the parameter adjustment device 1.

Furthermore, on the basis of the evaluation index values and the features of machining corresponding to the command value generation parameter set candidates stored in the candidate information storage unit 15 of the parameter adjustment device 1, the preference information setting unit 16 may predict the feature of machining to be obtained when the preference information is set, and display the feature of machining on the display unit 17 or the like in association with the machining target shape 320. In one example, a method is possible in which the feature of machining of the evaluation index values closest to the set preference information among the evaluation index values corresponding to the command value generation parameter set candidates stored in the candidate information storage unit 15 of the parameter adjustment device 1, and the feature of machining of the evaluation index values before setting the preference information are linearly interpolated to predict the feature of machining for the set preference information.

The preference information may be set for all of the machining time, the machining accuracy, and the surface quality, or may be set only partially. In a case where the preference information is not set by the worker, the preference information setting unit 16 interprets that as synonymous with setting of the current evaluation index values as selection information, and sets the preference information.

Returning to FIG. 1, the display unit 17 displays stored information stored in the candidate information storage unit 15 in accordance with an instruction from the preference information setting unit 16. In one example, the display unit 17 displays the features of machining of the command value generation parameter set candidates and the respective evaluation index values in association with each other. In the case where the entire workpiece is machined under one condition, the display unit 17 displays the features of machining of the command value generation parameter set candidates and the respective evaluation index values in association with each other for the machining target shape 320. In the case where the entire workpiece is divided into a plurality of portions and machined under different conditions for each divided portion, the display unit 17 displays the features of machining of the command value generation parameter set candidates and the respective evaluation index values in association with each other for each machined curved surface or each machined edge in the machining target shape 320.

The second optimal solution search unit 18 searches for a command value generation parameter set corresponding to evaluation index values with which a difference from the preference information is minimized. That is, the second optimal solution search unit 18 searches for one command value generation parameter set from the plurality of command value generation parameter sets so that the evaluation index values approximate the preference information set by the preference information setting unit 16. Specifically, the second optimal solution search unit 18 repeatedly performs the operation of acquiring a difference between evaluation index values for evaluating the machining time, the machining accuracy, and the surface quality corresponding to a command value generation parameter set and the preference information possessed by the worker regarding the machining time, the machining accuracy, and the surface quality, and obtains a command value generation parameter set that minimizes the difference between the evaluation index values and the worker preference information. The number of command value generation parameter sets to be obtained may be one, or may be two or more. In the case where the entire workpiece is machined under one condition, the second optimal solution search unit 18 obtains a command value generation parameter set that minimizes the difference between the evaluation index values and the worker preference information for the machining target shape 320. In the case where the entire workpiece is divided into a plurality of portions and machined under different conditions for each divided portion, the second optimal solution search unit 18 obtains a command value generation parameter set that minimizes the difference between the evaluation index values and the worker preference information for each machined curved surface and each machined edge in the machining target shape 320.

With the command value generation parameter set, the evaluation index values corresponding to the command value generation parameter set, and the difference between the evaluation index values and the worker preference information as learning data, the second optimal solution search unit 18 performs a learning process using a neural network. If a relationship between the command value generation parameters and the difference between the evaluation index values and the preference information can be obtained, a relationship between the command value generation parameter set and the difference between the evaluation index values and the preference information may be learned by using another method which is not the method using the neural network. In one example, in order to obtain the relationship between the command value generation parameter set and the difference between the evaluation index values and the preference information, a simple function such as a quadratic polynomial may be used, or a probability model such as a Gaussian process model may be used. As described above, the second optimal solution search unit 18 generates a second learning result for inferring, from the command value generation parameter set, the difference between the evaluation index values corresponding to the command value generation parameter set and the preference information by using the learning data including the command value generation parameter set and the difference between the evaluation index values corresponding to the command value generation parameter set and the preference information.

The difference between the evaluation index values and the worker preference information is three-dimensional data of the machining time, the machining accuracy, and the surface quality, but may be converted into one-dimensional data such as a norm and used as learning data.

Furthermore, as the second learning result in the second optimal solution search unit 18, the first learning result obtained on the basis of the learning process by the first optimal solution search unit 14 may be used, or a learning result obtained by additionally performing a learning process on the first learning result obtained on the basis of the learning process by the first optimal solution search unit 14 may be used.

The second optimal solution search unit 18 obtains, by numerical calculation, a command value generation parameter set that minimizes the difference between the evaluation index values and the worker preference information regarding the machining time, the machining accuracy, and the surface quality, on the basis of the relational formula between the command value generation parameter set and the difference between the evaluation index values and the preference information, the relational formula being the learning result. In other words, the second optimal solution search unit 18 infers the difference between the evaluation index values corresponding to the search command value generation parameter set and the preference information by using the second learning result which is a relational formula for inferring, from the command value generation parameter set, the difference between the evaluation index values corresponding to the command value generation parameter set and the preference information, and, by using a result of the inference, searches for one command value generation parameter set that minimizes the difference between the evaluation index values and the preference information. In one example, the second optimal solution search unit 18 obtains the search command value generation parameter set by using an optimization algorithm such as grid search, random search, Newton's method, Bayesian optimization, or evolutionary computation. Examples of evolutionary computation include NSGA-II, AGE-MOEA, AGE-MOEA2, and R-NSGA-II.

The second optimal solution search unit 18 obtains a difference between the evaluation index values and the worker preference information obtained by inputting the obtained search command value generation parameter set to the relational formula. Then, a command value generation parameter set that minimizes the difference between the evaluation index values and the preference information is obtained. At that time, it is desirable to obtain one command value generation parameter set that minimizes the difference between the evaluation index values and the preference information. However, a plurality of command value generation parameter sets may be obtained in order of smallest difference between the evaluation index values and the preference information obtained thereby, or all command value generation parameter sets with which the difference between the evaluation index values and the preference information does not exceed a threshold set by the worker may be obtained. That is, the second optimal solution search unit 18 may search for a command value generation parameter set corresponding to evaluation index values with which the difference from the preference information does not exceed a certain value. In that case, the number of command value generation parameter sets searched for by the second optimal solution search unit 18 may be one, or may be two or more. The command value generation parameter set thus obtained is referred to as a post-adjustment command value generation parameter set. The second optimal solution search unit 18 stores the calculated post-adjustment command value generation parameter set in the post-adjustment command value generation parameter set storage unit 19. The search command value generation parameter set used by the second optimal solution search unit 18 corresponds to a second search command value generation parameter set, which is a second command value generation parameter set for search. The second optimal solution search unit 18 can simultaneously perform a learning process and an inference process, as well.

The post-adjustment command value generation parameter set storage unit 19 stores the post-adjustment command value generation parameter set searched for by the second optimal solution search unit 18. In the case where the entire workpiece is machined under one condition, the post-adjustment command value generation parameter set storage unit 19 stores a post-adjustment command value generation parameter set calculated for the machining target shape 320. In the case where the entire workpiece is divided into a plurality of portions and machined under different conditions for each divided portion, the post-adjustment command value generation parameter set storage unit 19 stores a post-adjustment command value generation parameter set calculated for each machined curved surface and each machined edge in the machining target shape 320. The command value generation device 3 rewrites the setting values of the command value generation parameter set with the post-adjustment command value generation parameter set extracted by the second optimal solution search unit 18. The command value generation device 3 is operated with the use of the set command value generation parameters to perform machining, and thereby a machining result in line with the worker's preference can be obtained.

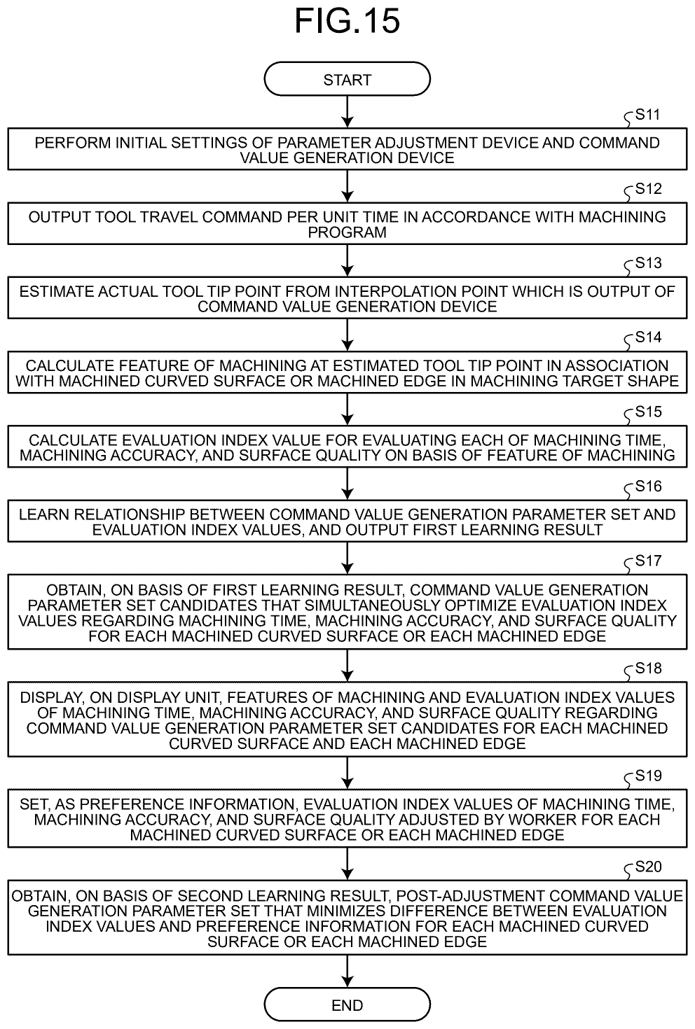

Next, a parameter adjustment method performed by the parameter adjustment device 1 having such a configuration will be described. FIG. 15 is a flowchart illustrating an example of a procedure of a parameter adjustment method according to the first embodiment. Here, as an example, the case will be described where the entire workpiece is divided into a plurality of portions, and machining is performed under different conditions for each divided portion.

First, initial settings of the parameter adjustment device 1 and the command value generation device 3 are performed (step S11). Specifically, the machining target shape 320, which is a target shape of the workpiece including a machined curved surface which is a curved surface to be machined, is externally input to the parameter adjustment device 1. In addition, the machining program 310, in which a travel command for a tool path corresponding to the machining target shape 320 and a travel velocity command at that time are described, is externally input to the command value generation device 3.

Next, the command value generation device 3 outputs a tool travel command per unit time in accordance with the machining program 310 that has been externally input (step S12). Thereafter, the feature calculation unit 11 simulates the behavior of the machine tool as a target to be controlled on a computer, and estimates an actual tool tip point from an interpolation point which is output of the command value generation device 3 (step S13).

Next, the feature calculation unit 11 calculates, for each tool tip point estimated in step S13, the feature of machining at the tool tip point in association with a machined curved surface or a machined edge in the machining target shape 320 (step S14). Thereafter, the evaluation index calculation unit 12 calculates an evaluation index value for evaluating each of the machining time, the machining accuracy, and the surface quality on the basis of the feature of machining calculated in step S14 (step S15).

Next, the first optimal solution search unit 14 receives the evaluation index values regarding the machining time, the machining accuracy, and the surface quality, and a parameter range as inputs, learns a relationship between the command value generation parameter set and the evaluation index values calculated by the evaluation index calculation unit 12, and outputs a first learning result (step S16). Thereafter, on the basis of a relational formula between the command value generation parameters and the evaluation index values which is the first learning result, the first optimal solution search unit 14 obtains, by numerical calculation, command value generation parameter set candidates that differ in the balance among the evaluation index values regarding the machining time, the machining accuracy, and the surface quality, and simultaneously optimize the evaluation index values regarding the machining time, the machining accuracy, and the surface quality, for each machined curved surface or each machined edge in the machining target shape 320 (step S17). In one example, four command value generation parameter set candidates of the machining time priority mode, the machining accuracy priority mode, the surface quality priority mode, and the balance mode are obtained for each machined curved surface or each machined edge. The number of command value generation parameter set candidates to be obtained for each machined curved surface or each machined edge may be one, or may be two or more.

Thereafter, regarding the command value generation parameter set candidates for which the features of machining have been acquired, the preference information setting unit 16 displays, on the display unit 17, the features of machining and the evaluation index values of the machining time, the machining accuracy, and the surface quality of the command value generation parameter set candidates, for each machined curved surface and each machined edge (step S18). That is, the preference information setting unit 16 displays, on the display unit 17, the features of machining calculated when the command value generation parameter set candidates are set on the command value generation device 3 and the command value generation device 3 operates, and the respective evaluation index values in association with each other. As described above, the features of machining and the respective evaluation index values of the command value generation parameter set candidates are associated with each other and displayed to the worker. Thereafter, the worker can select a feature of machining, that is, a command value generation parameter set, corresponding to the evaluation index values in line with the worker's preference or close to the worker's preference from the displayed ones, and as a result, it is possible to achieve convergence of the command value generation parameters on the worker's preference.

One command value generation parameter set candidate is selected by the worker for each machined curved surface and each machined edge on the basis of the feature of machining, and the evaluation index values of the machining time, the machining accuracy, and the surface quality are adjusted as necessary. The preference information setting unit 16 sets, as the preference information, the evaluation index values of the machining time, the machining accuracy, and the surface quality adjusted by the worker, for each machined curved surface or each machined edge (step S19).

Next, on the basis of the second learning result, the second optimal solution search unit 18 repeatedly performs the operation of acquiring a difference between the evaluation index values for evaluating the machining time, the machining accuracy, and the surface quality corresponding to the command value generation parameter set and the preference information possessed by the worker regarding the machining time, the machining accuracy, and the surface quality, and obtains a post-adjustment command value generation parameter set which is a command value generation parameter set that minimizes the difference between the evaluation index values and the worker preference information, for each machined curved surface or each machined edge in the machining target shape 320 (step S20).

Thereafter, the command value generation device 3 rewrites the setting values of the command value generation parameter set with the post-adjustment command value parameter set extracted by the second optimal solution search unit 18, performs an operation to execute machining, and thereby a machining result in line with the worker's preference can be obtained. In a case where the worker's preference changes, it is possible to calculate an optimal post-adjustment command value generation parameter set for the worker whose preference has changed in a short time by resuming the processes from step S18 to step S20 in which the worker's preference is reflected. This completes the parameter adjustment method. Note that, although the outline of each step has been described here, details of each step are as described above.

In the case where the entire workpiece is machined under one condition, in step S14, the feature calculation unit 11 calculates the feature of machining at the tool tip point in association with the machining target shape 320. In step S17, the first optimal solution search unit 14 obtains a command value generation parameter set candidate for the machining target shape 320. In step S18, the preference information setting unit 16 displays, on the display unit 17, the feature of machining and the evaluation index values of the machining time, the machining accuracy, and the surface quality of the command value generation parameter set candidate for the machining target shape 320. In step S19, the preference information setting unit 16 sets, as the preference information, the evaluation index values of the machining time, the machining accuracy, and the surface quality adjusted by the worker for the machining target shape 320. Then, in step S20, the second optimal solution search unit 18 obtains a post-adjustment command value generation parameter set for the machining target shape 320.

As described above, in the first embodiment, the evaluation index values corresponding to the search command value generation parameter set is inferred by using the first learning result for inferring one or more evaluation index values for evaluating the machining result from the command value generation parameter set, and, by using a result of the inference, a plurality of command value generation parameter set candidates that simultaneously optimize the respective evaluation index values are searched for. Then, the features of machining calculated when the searched command value generation parameter set candidates are set on the command value generation device 3 and the command value generation device 3 is operated and the respective evaluation index values are associated with each other and displayed on the display unit 17. Consequently, the worker can visually recognize the evaluation index values and the features of machining for the plurality of command value generation parameter set candidates and select, as the command value generation parameter set, a command value generation parameter set candidate in line with the worker's preference or a command value generation parameter set candidate close to the worker's preference. Then, with the use of the selected command value generation parameter set, it is possible to achieve convergence on the command value generation parameter set in line with the worker's preference faster than before. That is, it is possible to provide the worker with an environment in which convergence on the command value generation parameter set in line with the worker's preference can be achieved faster than the prior art.

In addition, according to the first embodiment, it is possible to automatically adjust the parameters for the machining target shape 320 in line with the worker's preference by using the three evaluation indexes of the machining time, the machining accuracy, and the surface quality. Consequently, it is possible to realize machining in shortest machining time while satisfying desired machining accuracy. That is, an effect is achieved that it is possible to achieve convergence of the command value generation parameter set in line with the worker's preference faster than before.

In a case where an adjustment result in line with the worker's preference cannot be obtained, or in a case where the worker's preference changes, it is only required to execute the processes from step S18 to step S20 in FIG. 15. Consequently, the worker can finely adjust and correct the command value generation parameter set with less labor and time.

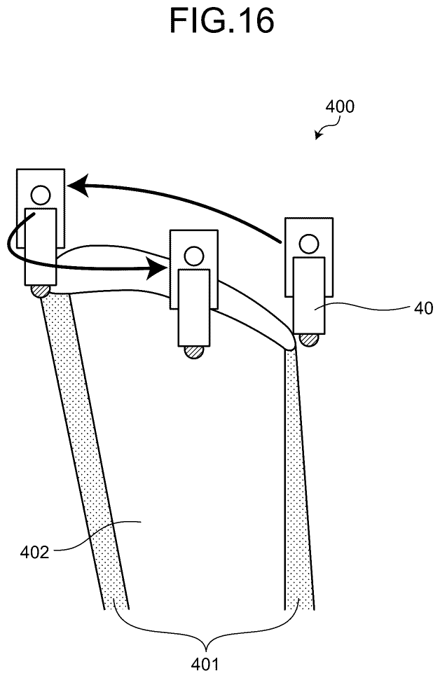

Furthermore, with the technique described in Patent Literature 1, it is possible to check the operation with a plurality of parameter sets and to select the most appropriate parameter set among the plurality of parameter sets, but a parameter set of one condition is applied through a series of machining operations. That is, with the technique described in Patent Literature 1, it is not possible to partially set an optimal parameter. FIG. 16 is a diagram illustrating an example of how a member in a blade shape is machined. As illustrated in FIG. 16, in one example, in a case where a member 400 in a blade shape is machined by using a tool 40, and it is desired to machine both-end portions 401 in a rounded shape with high accuracy and to machine a flat portion 402 between the both-end portions 401 at a high speed, it is not possible to address the case by a parameter set of one condition. Furthermore, in a case where a test program used for parameter adjustment includes a difference from the shape of a workpiece to be machined by the worker, the accuracy of the parameter adjustment deteriorates, and thus an adjustment result in line with the worker's preference cannot be obtained. However, in the first embodiment, in the case where the entire workpiece is divided into a plurality of portions and machined under different conditions for each divided portion, the post-adjustment command value generation parameter set reflecting the worker's preference is obtained for each machined curved surface and each machined edge in the machining target shape 320. In the example in FIG. 16, different post-adjustment command value generation parameters reflecting the worker's preference are obtained for the both-end portions 401 and the flat portion 402. Consequently, it is possible to achieve convergence of the command value generation parameter set corresponding to the evaluation index values in line with the worker's preference faster than before while considering a shape of the entirety or part of the workpiece. In addition, there is an effect that machining can be performed depending on the worker's preference for each portion of one workpiece.

Note that the learning data used by the second optimal solution search unit 18 may be data acquired from the same target to be controlled as the target to be controlled from which the learning data used by the first optimal solution search unit 14 is acquired. In addition, the learning data used by the second optimal solution search unit 18 may be data acquired from a target to be controlled different from the target to be controlled from which the learning data used by the first optimal solution search unit 14 is acquired. That is, the learning results of the first optimal solution search unit 14 and the second optimal solution search unit 18 in the first embodiment may be learning results obtained in different targets to be controlled. In one example, the learning result of the second optimal solution search unit 18 may be a learning result obtained in the actual machine tool, and the learning result of the first optimal solution search unit 14 may be a learning result by simulation in which a behavior of the machine tool is simulated on a computer. With such a configuration, even in a case where a change in a state of the machine tool such as a change over time or a thermal variation occurs, a parameter can be automatically adjusted in line with the worker's preference by adjusting the parameter in line with the worker's preference in simulation to some extent, and then adjusting the parameter with high accuracy with a small number of adjustments in the actual machine tool.

### Second Embodiment

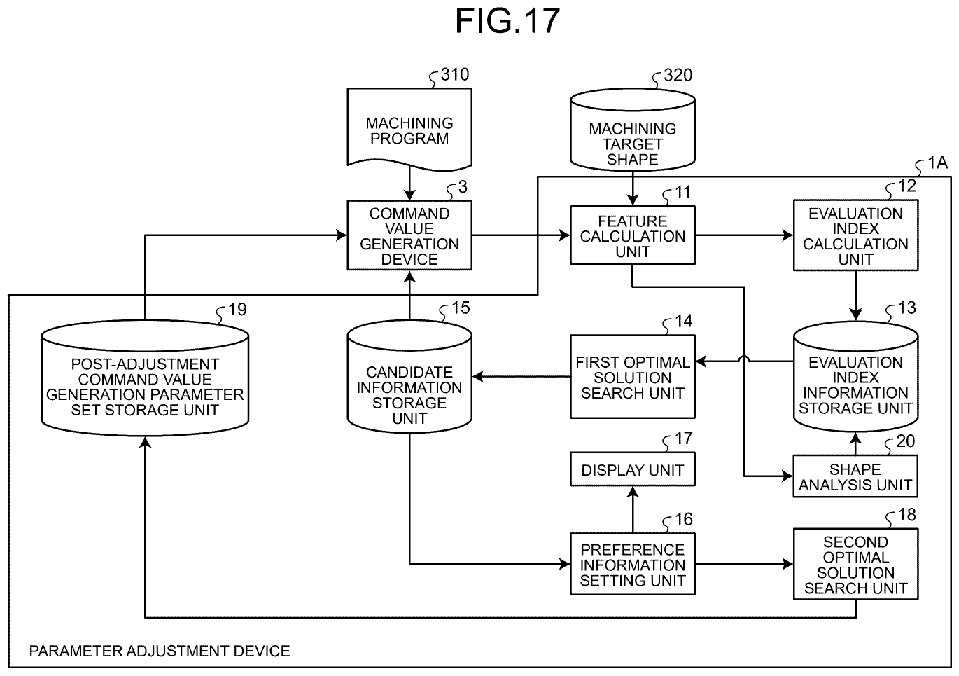

FIG. 17 is a diagram illustrating an example of a configuration of a parameter adjustment device according to a second embodiment. The same components as those in the first embodiment will be denoted by the same reference numerals as those therein, descriptions thereof will be omitted, and differences from the first embodiment will be described. A parameter adjustment device 1A further includes a shape analysis unit 20 that analyzes shape information which is information indicating the shape of the machining target shape 320 for each machined curved surface or each machined edge based on the feature of machining, in addition to the configuration of the first embodiment.

The shape analysis unit 20 analyzes the shape information which is information indicating the shape of the machining target shape 320 for each machined curved surface or each machined edge on the basis of the feature of machining calculated by the feature calculation unit 11. In one example, the shape analysis unit 20 extracts an adjacent path which is a tool tip point path adjacent to a representative tool tip point path for each machined curved surface or each machined edge in the machining target shape 320, and derives the shape information from the feature of machining corresponding to the extracted adjacent path. In one example, the shape analysis unit 20 uses, as the shape information, a cumulative value of tangent vector changes calculated from the feature of machining corresponding to the adjacent path. Alternatively, the shape analysis unit 20 may use, as the shape information, an average value of the tangential vector changes derived from the feature of machining. The feature of machining at that time is the velocity of the tool tip point. In another example, the shape analysis unit 20 uses, as the shape information, a function obtained by one-dimensionalization and fitting of a distance from the centroid of the adjacent path. At that time, the shape information may be that obtained by fitting with a simple function such as a quadratic polynomial.

Note that, regarding a method for extracting the adjacent path, in one example, the feature of machining corresponding to each machined curved surface or each machined edge in the machining target shape 320 is associated, so that the adjacent path is extracted by performing grouping for each feature of machining consecutive in time series.

The shape analysis unit 20 stores the shape information obtained on the basis of the adjacent path calculated as described above in the evaluation index information storage unit 13 in association with the command value generation parameter set and the evaluation index values regarding the machining time, the machining accuracy, and the surface quality. As described above, in the second embodiment, the evaluation index information includes the evaluation index values regarding the machining time, the machining accuracy, and the surface quality, the command value generation parameter set, and the shape information in association with each other, for each machined curved surface or each machined edge in the machining target shape 320. Note that the evaluation index information may include the evaluation index values regarding the machining time, the machining accuracy, and the surface quality, the command value generation parameter set, the shape information, and in addition thereto, a corresponding feature of machining.

The first optimal solution search unit 14 adds the shape information derived by the shape analysis unit 20 to the relationship between the command value generation parameter set which is a parameter set in the command value generation device 3 and the evaluation index values calculated by the evaluation index calculation unit 12 and performs learning to obtain a first learning result. The first optimal solution search unit 14 searches for one or more command value generation parameter sets that simultaneously optimize evaluation index values of the machining time, the machining accuracy, and the surface quality, by using the first learning result. In a case of searching for a plurality of command value generation parameter sets, the search is made for command value generation parameter sets that differ in the balance among the evaluation index values in a trade-off relationship and simultaneously optimize the evaluation index values of the machining time, the machining accuracy, and the surface quality.

Here, a learning process by the first optimal solution search unit 14 will be described. The first optimal solution search unit 14 receives the evaluation index values regarding the machining time, the machining accuracy, and the surface quality, the command value generation parameter set, and the shape information as inputs, learns a relationship among the command value generation parameters, the evaluation index values calculated by the evaluation index calculation unit 12, and the shape information, and outputs the first learning result.

Specifically, a neural network that receives the command value generation parameter set and the shape information as inputs and outputs the evaluation index values is configured, and the first optimal solution search unit 14 performs learning by updating a weight coefficient of the neural network.

The first optimal solution search unit 14 selects, from a defined parameter range, a command value generation parameter set for executing the next machining operation in the machining target shape 320 and outputs the selected command value generation parameter set. When selecting the next command value generation parameter set, the first optimal solution search unit 14 may select a command value generation parameter set indicating excellent evaluation index values on the basis of the first learning result, or may sequentially select respective command value generation parameter sets from grid points located at equal intervals. The first optimal solution search unit 14 has a function of updating a function for calculating evaluation index values regarding the machining time, the machining accuracy, and the surface quality on the basis of the command value generation parameter set and the shape information.

The first optimal solution search unit 14 repeatedly performs the operation of acquiring the evaluation index values corresponding to the command value generation parameter set and the shape information. With the command value generation parameter set and the evaluation index values and the shape information corresponding to the command value generation parameter set as learning data, the first optimal solution search unit 14 performs the learning process using the neural network as described in the first embodiment.

By the above operation, the function that receives the command value generation parameter set and the shape information as inputs and outputs the evaluation index values, the function being a relational formula by the neural network, is obtained as the first learning result.

Use of the first learning result makes it possible to obtain the evaluation index values Qt, Qa, and Qq regarding the machining time, the machining accuracy, and the surface quality corresponding to a new command value generation parameter set and new shape information without executing the machining operation on the new command value generation parameter set and shape information.

In the second embodiment, the neural network is used to construct the relational formula among the command value generation parameter set, the shape information, and the evaluation index values. However, a method other than the neural network may be used as long as the relationship among the command value generation parameter set, the shape information, and the evaluation index values can be obtained. In one example, in order to obtain the relational formula among the command value generation parameter set, the shape information, and the evaluation index values, a simple function such as a quadratic polynomial may be used, or a probability model such as a Gaussian process model may be used.

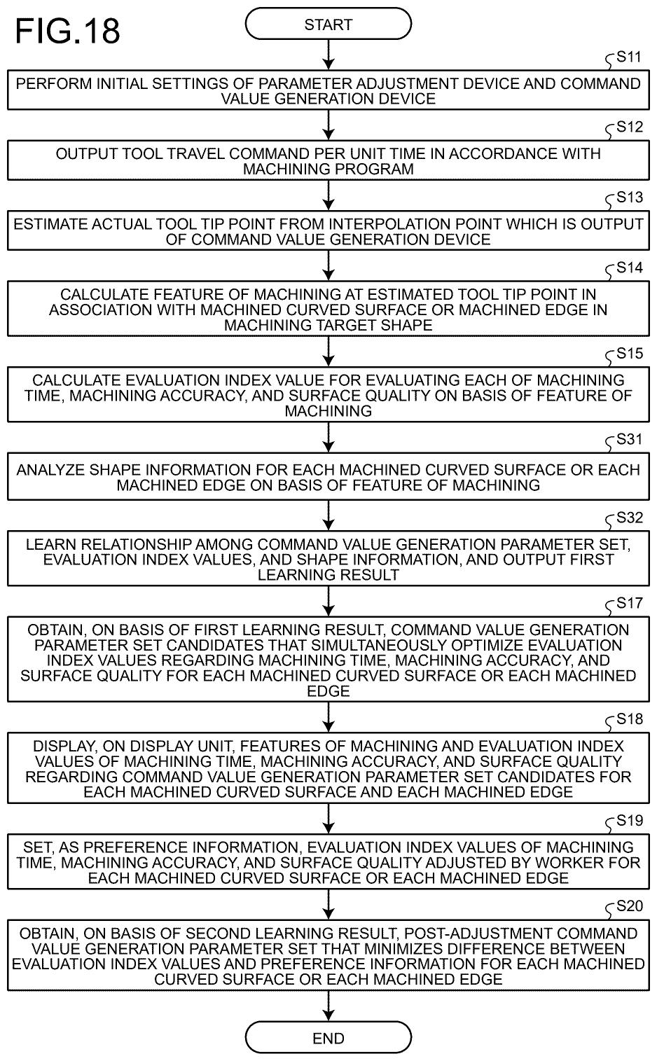

Next, a parameter adjustment method in the second embodiment will be described. FIG. 18 is a flowchart illustrating an example of a procedure of a parameter adjustment method according to the second embodiment. Note that the same processes as those in FIG. 15 of the first embodiment are denoted by the same step numbers, and the descriptions thereof will be omitted.

In the second embodiment, after step S15, the shape analysis unit 20 analyzes the shape information for each machined curved surface or each machined edge in the machining target shape 320 on the basis of the feature of machining calculated in step S14 (step S31). Next, instead of the process of step S16, the first optimal solution search unit 14 receives the evaluation index values regarding the machining time, the machining accuracy, and the surface quality, the command value generation parameter set, and the shape information as inputs, learns a relationship among the command value generation parameter set, the evaluation index values calculated by the evaluation index calculation unit 12, and the shape information, and outputs the first learning result (step S32). Thereafter, the process proceeds to step S17.

As described above, according to the second embodiment, the shape information of a machined curved surface or a machined edge is added to the first embodiment and learning is performed, thereby obtaining the first learning result. Consequently, even in a case where the machining target shape 320 desired by the worker is changed, the parameters can be automatically adjusted in line with the worker's preference for each machined curved surface or each machined edge in the machining target shape 320 by using the three evaluation index values of the machining time, the machining accuracy, and the surface quality.

Note that the first learning result of the first optimal solution search unit 14 and the second learning result of the second optimal solution search unit 18 in the second embodiment may be the first learning result and the second learning result obtained in different targets to be controlled similarly to the first embodiment. In one example, the second optimal solution search unit 18 may use a second learning result using learning data obtained in an actual machine tool, and the first optimal solution search unit 14 may use a first learning result using learning data obtained in a simulation in which the behavior of the machine tool is simulated on a computer. With such a configuration, even in a case where a change in a state of the machine tool such as a change over time or a thermal variation occurs, a command value generation parameter set can be automatically adjusted in line with the worker's preference by adjusting the command value generation parameter set in line with the worker's preference in simulation to some extent, and then adjusting the command value generation parameter set with high accuracy with a small number of adjustments in the actual machine tool. Of course, the first learning result of the first optimal solution search unit 14 and the second learning result of the second optimal solution search unit 18 may be the first learning result and the second learning result obtained in the same target to be controlled.

The first learning result of the first optimal solution search unit 14 and the second learning result of the second optimal solution search unit 18 in the second embodiment may be the first learning result and the second learning result obtained in different machining programs 310. In one example, the first optimal solution search unit 14 may obtain the first learning result by using the machining program 310 in general use capable of accommodating various types of shape information, and the second optimal solution search unit 18 may obtain the second learning result by using the machining program 310 for the machining target shape 320 desired by the worker. Consequently, even in a case where the machining target shape 320 desired by the worker is changed, the command value generation parameter set can be automatically adjusted with less labor and time for the worker.

Next, a hardware configuration of the parameter adjustment devices 1 and 1A will be described. In the parameter adjustment devices 1 and 1A of the first and second embodiments, a program is executed on a computer system, the program being a computer program in which processes performed by the parameter adjustment devices 1 and 1A are described, and thereby the computer system functions as the parameter adjustment devices 1 and 1A.

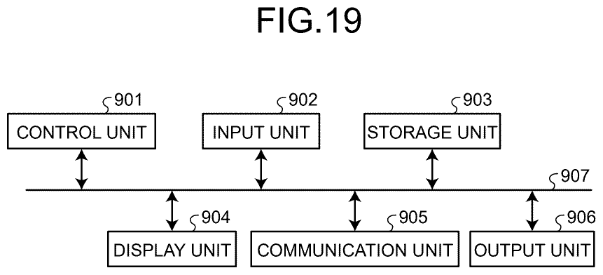

FIG. 19 is a diagram illustrating an example of a configuration of a computer system that realizes the parameter adjustment devices according to the first and second embodiments. As illustrated in FIG. 19, the computer system includes a control unit 901, an input unit 902, a storage unit 903, a display unit 904, a communication unit 905, and an output unit 906, which are connected via a system bus 907.

In FIG. 19, the control unit 901 is a processor such as a central processing unit (CPU) in one example, and executes a program in which processes performed by the parameter adjustment devices 1 and 1A of the first and second embodiments are described. The input unit 902 includes a keyboard, a mouse, or the like in one example, and is used by a user of the computer system in order to input various information. The storage unit 903 includes various memories such as a random access memory (RAM) and a read only memory (ROM), and a storage device such as a hard disk, and stores programs to be executed by the control unit 901, necessary data obtained during processes, and the like. The storage unit 903 is also used as a temporary storage area of a program. The display unit 904 includes a display, a liquid crystal display panel, or the like, and displays various screens to the user of the computer system. In one example, the input unit 902 and the display unit 904 may include a touch panel in which the input unit 902 and the display unit 904 are integrally formed. The communication unit 905 is a receiver and a transmitter that perform a communication process. The output unit 906 is a printer, a speaker, or the like. FIG. 19 is merely an example, and the configuration of the computer system is not limited to the example in FIG. 19.

Here, an example of an operation of the computer system until the program becomes executable will be described. In the computer system having the above-described configuration, the program is installed in the storage unit 903 from a compact disc (CD)-ROM or a digital versatile disc (DVD)-ROM set in a CD-ROM drive or a DVD-ROM drive (not illustrated), for example. Then, at the execution of the program, the program read from the storage unit 903 is stored in the main storage area of the storage unit 903. In that state, the control unit 901 executes processes as the parameter adjustment devices 1 and 1A of the first and second embodiments in accordance with the program stored in the storage unit 903.

In the above description, the program in which processes performed by the parameter adjustment devices 1 and 1A are described is provided by using the CD-ROM or the DVD-ROM as a recording medium, but there is no limitation thereto. For example, a program provided by a transmission medium such as the Internet via the communication unit 905 may be used depending on the configuration of the computer system, the capacity of the program to be provided, and the like.

The feature calculation unit 11, the evaluation index calculation unit 12, the first optimal solution search unit 14, the preference information setting unit 16, and the second optimal solution search unit 18 of each of the parameter adjustment devices 1 and 1A illustrated in FIGS. 1 and 17, and the shape analysis unit 20 illustrated in FIG. 17 are realized by the control unit 901 illustrated in FIG. 19 executing a program stored in the storage unit 903 illustrated in FIG. 19. The storage unit 903 illustrated in FIG. 19 is also used to realize the feature calculation unit 11, the evaluation index calculation unit 12, the first optimal solution search unit 14, the preference information setting unit 16, the second optimal solution search unit 18, and the shape analysis unit 20. The evaluation index information storage unit 13, the candidate information storage unit 15, and the post-adjustment command value generation parameter set storage unit 19 are realized by the storage unit 903 illustrated in FIG. 19. The display unit 17 is realized by the display unit 904 illustrated in FIG. 19.

The configurations described in the above embodiments are merely examples and can be combined with other known technology, the embodiments can be combined with each other, and part of the configurations can be omitted or modified without departing from the gist thereof.

### REFERENCE SIGNS LIST

1, 1A parameter adjustment device; 3 command value generation device; 11 feature calculation unit; 12 evaluation index calculation unit; 13 evaluation index information storage unit; 14 first optimal solution search unit; 15 candidate information storage unit; 16 preference information setting unit; 17 display unit; 18 second optimal solution search unit; 19 post-adjustment command value generation parameter set storage unit; 20 shape analysis unit; 310 machining program; 320 machining target shape; 321 block; 321a upper surface; 322 protrusion; E1, E2 machined edge; S1, S2, S3 machined curved surface.

1. A parameter adjustment device that adjusts a command value generation parameter set that is a plurality of parameters used to generate a tool travel command including a group of interpolation points per unit time on a tool path calculated on a basis of a machining program for machining a workpiece, the parameter adjustment device comprising:
feature calculation circuitry to calculate a feature of machining by simulating an operation of a machine tool to be controlled on a basis of the tool travel command;
evaluation index calculation circuitry to calculate one or more evaluation index values for evaluating a machining result on a basis of the feature of machining;
first optimal solution search circuitry to infer the evaluation index values corresponding to a first search command value generation parameter set by using a first learning result for inferring the evaluation index values from the command value generation parameter set that has been learned by using the command value generation parameter set and the evaluation index values, and to, by using a result of inference, search for command value generation parameter set candidates that are a plurality of command value generation parameter sets that simultaneously optimize the respective evaluation index values; and
display control circuitry to display, on a display, the feature of machining calculated when the command value generation parameter set candidates are set on a command value generation device that generates the tool travel command and the command value generation device operates, and the respective evaluation index values in association with each other.

2. The parameter adjustment device according to claim 1, wherein the display control circuitry sets preference information for the respective evaluation index values of the command value generation parameter set candidates selected by a worker among the feature of machining and the respective evaluation index values displayed on the display.

3. The parameter adjustment device according to claim 2, further comprising second optimal solution search circuitry to search for a command value generation parameter set corresponding to evaluation index values with which a difference from the preference information is minimized.

4. The parameter adjustment device according to claim 2, further comprising second optimal solution search circuitry to search for a command value generation parameter set corresponding to evaluation index values with which a difference from the preference information does not exceed a certain value.

5. The parameter adjustment device according to claim 3, wherein the second optimal solution search circuitry infers a difference between the evaluation index values corresponding to a second search command value generation parameter set and the preference information by using a second learning result for inferring a difference between the evaluation index values corresponding to the command value generation parameter set and the preference information from the command value generation parameter set, and, by using a result of inference, searches for a command value generation parameter set that minimizes a difference between the evaluation index values and the preference information.

6. The parameter adjustment device according to claim 5, wherein the second optimal solution search circuitry has a function of generating the second learning result by using learning data including the command value generation parameter set and a difference between the evaluation index values corresponding to the command value generation parameter set and the preference information.

7. The parameter adjustment device according to claim 3, wherein the first optimal solution search circuitry has a function of generating the first learning result by using learning data including the command value generation parameter set and the evaluation index values.

8. The parameter adjustment device according to claim 7, wherein the learning data used by the second optimal solution search circuitry is data acquired from a same target to be controlled as a target to be controlled from which the learning data used by the first optimal solution search circuitry is acquired.

9. The parameter adjustment device according to claim 7, wherein the learning data used by the second optimal solution search circuitry is data acquired from a target to be controlled different from a target to be controlled from which the learning data used by the first optimal solution search circuitry is acquired.

10. The parameter adjustment device according to claim 2, wherein
the feature calculation circuitry calculates the feature of machining for each of one or more shape components included in a machining target shape that is target shape data of a workpiece including a machined curved surface that is a curved surface to be machined,
the first optimal solution search circuitry searches for the command value generation parameter set candidates for each of the shape components, and
the display control circuitry sets the respective evaluation index values of the command value generation parameter set candidates selected and adjusted by the worker as preference information for each of the shape components.

11. The parameter adjustment device according to claim 1, wherein
the feature of machining is a velocity of a tool tip point,
one of the evaluation index values is an evaluation index value regarding a machining time, and
the evaluation index value regarding the machining time is a deceleration rate of a velocity of the tool tip point with respect to a command velocity described in the machining program.

12. The parameter adjustment device according to claim 1, wherein
the feature of machining is an amount of machining error that is a distance between a machining target shape that is target shape data of a workpiece including a machined curved surface that is a curved surface to be machined and a tool disposed at a position of a tool tip point,
one of the evaluation index values is an evaluation index value regarding machining accuracy, and
the evaluation index value regarding the machining accuracy is an average value of the amount of machining error.

13. The parameter adjustment device according to claim 1, wherein
the feature of machining is an amount of machining error that is a distance between a machining target shape that is target shape data of a workpiece including a machined curved surface that is a curved surface to be machined and a tool disposed at a position of a tool tip point,
one of the evaluation index values is an evaluation index value regarding surface quality, and
the evaluation index value regarding the surface quality is a variance value of the amount of machining error.

14. The parameter adjustment device according to claim 10, further comprising:
shape analysis circuitry to analyze shape information that is information indicating a shape of the machining target shape for each of the shape components on a basis of the feature of machining calculated by the feature calculation circuitry, wherein
the first optimal solution search circuitry
adds the shape information to a relationship between the command value generation parameter set and the evaluation index values and performs learning to generate the first learning result, and
infers the evaluation index values corresponding to the first search command value generation parameter set and the shape information by using the first learning result.

15. The parameter adjustment device according to claim 14, wherein the shape analysis circuitry uses, as the shape information, a cumulative value of tangent vector changes calculated from the feature of machining corresponding to an adjacent path that is a tool tip point path adjacent to a representative tool tip point path for each of the shape components or a function obtained by one-dimensionalization and fitting of a distance from a centroid of the adjacent path.

16. A parameter adjustment method performed by a parameter adjustment device that adjusts a command value generation parameter set that is a plurality of parameters used to generate a tool travel command including a group of interpolation points per unit time on a tool path calculated on a basis of a machining program for machining a workpiece, the parameter adjustment method comprising:
calculating a feature of machining by simulating an operation of a machine tool to be controlled from the tool travel command;
calculating one or more evaluation index values for evaluating a machining result from the feature of machining;
inferring the evaluation index values corresponding to a first search command value generation parameter set by using a first learning result for inferring the evaluation index values from the command value generation parameter set that has been learned by using the command value generation parameter set and the evaluation index values, and, by using a result of inference, searching for command value generation parameter set candidates that are a plurality of command value generation parameter sets that simultaneously optimize the respective evaluation index values; and
displaying, on a display unit, the feature of machining calculated when the command value generation parameter set candidates are set on a command value generation device that generates the tool travel command and the command value generation device operates, and the respective evaluation index values in association with each other.

17. The parameter adjustment device according to claim 4, wherein the second optimal solution search circuitry infers a difference between the evaluation index values corresponding to a second search command value generation parameter set and the preference information by using a second learning result for inferring a difference between the evaluation index values corresponding to the command value generation parameter set and the preference information from the command value generation parameter set, and, by using a result of inference, searches for a command value generation parameter set that minimizes a difference between the evaluation index values and the preference information.

18. The parameter adjustment device according to claim 4, wherein the first optimal solution search circuitry has a function of generating the first learning result by using learning data including the command value generation parameter set and the evaluation index values.
